(19) United States
(12) Patent Application Publication
(10) Pub. No.: US 2024/0251460 A1
(43) Pub. Date: Jul. 25, 2024

(54) BICYCLE COMPONENT

(71) Applicant: Shimano Inc., Osaka (JP)

(72) Inventors: Akihiro NOZAKI, Osaka (JP); Katsuhiro TACHIBANA, Osaka (JP); Naoki FUJIMOTO, Osaka (JP); Kentaro TANAKA, Osaka (JP)

(21) Appl. No.: 18/101,262

(22) Filed: Jan. 25, 2023

(51) Int. Cl. H04W 76/15; H04W 52/02; H04W 76/19

(52) U.S. Cl. CPC H04W 76/15; H04W 52/0274; H04W 76/19

(57) ABSTRACT

A bicycle component is basically provided with a communicator and a controller. The communicator is configured to wirelessly receive a pairing trigger signal generated in response to a user trigger input of a trigger input device, and to wirelessly receive a first pairing demand signal generated in response to a first user input of a first input device. The controller is configured to cause the bicycle component to enter a pairing mode in response to the pairing trigger signal being received by the communicator. The controller is configured to establish wireless communication between the bicycle component and a first remote component that sent the first pairing demand signal in a state where the bicycle component is in the pairing mode.

### BACKGROUND

### Technical Field

This disclosure generally relates to a bicycle component. More specifically, the present disclosure relates to a bicycle component configured to wirelessly communicate with a user input.

### Background Information

In recent years, some bicycles are provided with electric components or devices to make it easier for the rider to operate the bicycle. Examples of such electric components include suspensions, transmission devices (e.g., derailleurs, internally geared hubs, etc.), operating devices and seatposts. Typically, each the electric components is operated by an operating devices that interconnects the operating device to the electric component. In more recent years, control systems exist that wirelessly interconnect the electric components to the operating devices.

### SUMMARY

Generally, the present disclosure is directed to various features of a pairing a bicycle component to a user input.

In view of the state of the known technology and in accordance with a first aspect of the present disclosure, a bicycle component is provided that basically comprises a communicator and a controller. The communicator is configured to wirelessly receive a pairing trigger signal generated in response to a user trigger input of a trigger input device, and to wirelessly receive a first pairing demand signal generated in response to a first user input of a first input device. The controller is configured to cause the bicycle component to enter a pairing mode in response to the pairing trigger signal being received by the communicator. The controller is configured to establish wireless communication between the bicycle component and a first remote component that sent the first pairing demand signal in a state where the bicycle component is in the pairing mode.

With the bicycle component according to the first aspect, the pairing process easily started between a bicycle component and a first input device and subsequently established reliably wireless communications between the bicycle component and the first remote component.

In accordance with a second aspect of the present disclosure, the bicycle component according to the first aspect is configured so that the first remote component includes at least one of the trigger input device and the first input device.

With the bicycle component according to the second aspect, at least one of the pairing trigger signal and the first pairing demand signal is generated by the first remote component.

In accordance with a third aspect of the present disclosure, the bicycle component according to the first aspect or the second aspect is configured so that the first input device includes the trigger input device.

With the bicycle component according to the third aspect, the pairing trigger signal and the first pairing demand signal are generated by the first input device.

In accordance with a fourth aspect of the present disclosure, the bicycle component according to the third aspect is configured so that the first user input includes an input to a first interface of the first input device, and the user trigger input includes an input to the first interface.

With the bicycle component according to the fourth aspect, a first interface of the first input device can be used to generate the pairing trigger signal and the first pairing demand signal.

In accordance with a fifth aspect of the present disclosure, the bicycle component according to any one of the first aspect to the fourth aspect is configured so that the bicycle component is configured to enter a wireless signal listening mode in response to a trigger. The controller is configured to cause the bicycle component to exit the wireless signal listening mode and to enter the pairing mode in response to the pairing trigger signal being received by the communicator.

With the bicycle component according to the fifth aspect, the bicycle component easily enters a wireless signal listening mode in response to a trigger.

In accordance with a sixth aspect of the present disclosure, the bicycle component according to the fifth aspect is configured so that the trigger includes at least one of providing electrical power to the bicycle component, connecting a power source to the bicycle component, connecting an electrical cable connected to an additional bicycle component, and operating an additional control device configured to control the additional bicycle component.

With the bicycle component according to the sixth aspect, the bicycle component can immediately enter the wireless signal listening mode once electrical power is suppled to the bicycle component.

In accordance with a seventh aspect of the present disclosure, the bicycle component according to the fifth aspect or the sixth aspect is configured so that the controller is configured to prohibit the bicycle component from entering the wireless signal listening mode in a state where wireless communication between the bicycle component and the first remote component is established.

With the bicycle component according to the seventh aspect, the bicycle component can be immediately operated by the first remote component without entering the wireless signal listening mode.

In accordance with an eighth aspect of the present disclosure, the bicycle component according to any one of the fifth aspect to the seventh aspect is configured so that the controller is configured to cause the bicycle component to exit the wireless signal listening mode after a first predetermined time as elapsed from entering the wireless signal listening mode.

With the bicycle component according to the eighth aspect, it is possible to reduce the consumption of electrical power by exiting the wireless signal listening mode after a first predetermined time as elapsed from entering the wireless signal listening mode.

In accordance with a ninth aspect of the present disclosure, the bicycle component according to any one of the fifth aspect to the eighth aspect is configured so that the controller is configured to control the communicator such that the communicator operates intermittently in a state where the bicycle component is in the wireless signal listening mode.

With the bicycle component according to the ninth aspect, it is possible to reduce the consumption of electrical power by intermittently operating the communicator in the wireless signal listening mode.

In accordance with a tenth aspect of the present disclosure, the bicycle component according to any one of the fifth aspect to the ninth aspect further comprises a signal amplifier coupled to the communicator. The controller is configured to control the signal amplifier such that the signal amplifier operates in a first power consumption state in a state where the bicycle component is in the wireless signal listening mode. The controller is configured to control the signal amplifier such that the signal amplifier operates in a second power consumption state in a state where the bicycle component is in the pairing mode. The first power consumption state has a lower power consumption than the second power consumption.

With the bicycle component according to the tenth aspect, it is possible to reduce improper pairing of the bicycle component with other devices.

In accordance with an eleventh aspect of the present disclosure, the bicycle component according to any one of the fifth aspect to the tenth aspect further comprises a notification device being configured to be controlled by the controller.

With the bicycle component according to the eleventh aspect, it is possible to notify a user when an operating state of the bicycle component changes.

In accordance with a twelfth aspect of the present disclosure, the bicycle component according to the eleventh aspect is configured so that the notification device includes a light emitting device.

With the bicycle component according to the twelfth aspect, a user can be easily and reliably notified of an operating state of the bicycle component using a light emitting device.

In accordance with a thirteenth aspect of the present disclosure, the bicycle component according to the eleventh aspect or the twelfth is configured so that the notification device is configured to produce a notification after at least one of informing information is generated by the first remote component and the first user input has finished.

With the bicycle component according to the thirteenth aspect, a user can be notified of an operating state of the bicycle component at an appropriate time.

In accordance with a fourteenth aspect of the present disclosure, the bicycle component according to any one of the eleventh aspect to the thirteenth aspect is configured so that the controller is configured to activate the notification device to produce a first notification in response to entrance of the bicycle component to the pairing mode.

With the bicycle component according to the fourteenth aspect, a user can be notified of the bicycle component entering the pairing mode by producing a first notification.

In accordance with a fifteenth aspect of the present disclosure, the bicycle component according to any one of the eleventh aspect to the fourteenth aspect is configured so that the controller is configured to activate the notification device to produce a second notification in a state where the bicycle component has been successfully paired.

With the bicycle component according to the fifteenth aspect, a user can be notified of the bicycle component having been successfully paired by producing a second notification.

In accordance with a sixteenth aspect of the present disclosure, the bicycle component according to any one of the first aspect to the fifteenth aspect is configured so that the controller is configured to cause the bicycle component to exit the pairing mode in response to a third user input of a third input device, and the third input device is provided on at least one of the bicycle component and the first remote component.

With the bicycle component according to the sixteenth aspect, the pairing mode can be easily exited by a user operating a third input device.

In accordance with a seventeenth aspect of the present disclosure, the bicycle component according to any one of the first aspect to the sixteenth aspect is configured so that the communicator is configured to wirelessly receive a second pairing demand signal generated in response to a second user input of a second input device, and the controller is configured to establish wireless communication between the bicycle component and a second remote component that sent the second pairing demand signal in a state where the bicycle component is in the pairing mode.

With the bicycle component according to the seventeenth aspect, it is possible to pair the bicycle component to at least two different remote components.

In accordance with an eighteenth aspect of the present disclosure, the bicycle component according to any one of the first aspect to the seventeenth aspect further comprises a first storage device configured to store a first device identification included in the first pairing demand signal that is received by the communicator.

With the bicycle component according to the eighteenth aspect, the first input device can be used to subsequently operate the bicycle component with being paired again by storing the first device identification.

In accordance with a nineteenth aspect of the present disclosure, the bicycle component according to the seventeenth aspect further comprises a first storage device configured to store at least one of device identifications including a first device identification and a second device identification. The first device identification is included in the first pairing demand signal that is received by the communicator. The second device identification is included in the second pairing demand signal that is received by the communicator. The controller is configured to control the bicycle component in accordance with a control signal including one of the device identifications stored in the first storage device.

With the bicycle component according to the nineteenth aspect, the bicycle component can be appropriately and reliably operated based on the device identifications stored in the first storage device.

In accordance with a twentieth aspect of the present disclosure, the bicycle component according to the eighteenth aspect or the nineteenth aspect is configured so that the controller is configured to clear the device identification stored in the first storage device in response to a reset operation of a reset interface.

With the bicycle component according to the twentieth aspect, it is possible to reset the bicycle component by clearing the device identification stored in the first storage device so that the bicycle component can be paired to a new input device as needed and/or desired.

In accordance with a twenty-first aspect of the present disclosure, the bicycle component according to the twentieth aspect further comprises the reset interface operatively coupled to the controller. The controller is configured to disable the reset operation upon a command from an external device.

With the bicycle component according to the twenty-first aspect, it is possible to prevent a user from accidently resetting the bicycle component.

In accordance with a twenty-second aspect of the present disclosure, the bicycle component according to any one of the first aspect to the twenty-first aspect is configured so that the controller is configured to cause the bicycle component to exit the pairing mode after a second predetermined time as elapsed.

With the bicycle component according to the twenty-second aspect, the bicycle component exits the pairing mode after a second predetermined time as elapsed to reduce the consumption of electrical power.

In accordance with a twenty-third aspect of the present disclosure, a bicycle control system is provided that comprises the bicycle component according to any one of the first aspect to the twenty-first aspect and further comprises the first remote component.

With the bicycle component according to the twenty-third aspect, the bicycle component and the first remote component can be appropriately matched.

In accordance with a twenty-fourth aspect of the present disclosure, a bicycle component is provided that basically comprises a communicator, a first storage device and a controller. The communicator is configured to wirelessly receive a first signal including a first device identification generated from a first communication device and a second signal including a second device identification generated from a second communication device. The first storage device is configured to store at least one of the first device identification and the second device identification. The controller is configured to control the bicycle component in response to the first signal in a state where neither the first device identification nor the second device identification is stored in the first storage device. The controller is configured to control the bicycle component in response to the second signal in a state where neither the first device identification nor the second device identification is stored in the first storage device. The controller is further configured to control the bicycle component in response to the first signal in a state where the first device identification is stored in the first storage device.

With the bicycle component according to the twenty-fourth aspect, the bicycle component can be controlled in response to either the first signal or the second signal in a state where neither the first device identification nor the second device identification is stored in the first storage device, but is controlled by the first signal in a state where the first device identification is stored in the first storage device.

In accordance with a twenty-fifth aspect of the present disclosure, the bicycle component according to the twenty-fourth aspect further comprises an actuator. The first signal including a first shifting signal. The controller is configured to control the actuator in response to the first shifting signal in a state where the first device identification is stored in the first storage device.

With the bicycle component according to the twenty-fifth aspect, the actuator of the bicycle component can be reliably controlled in response to the first shifting signal in a state where the first device identification is stored in the first storage device.

In accordance with a twenty-sixth aspect of the present disclosure, the bicycle component according to the twenty-fifth aspect is configured so that the controller is further configured to control the bicycle component such that the bicycle component is unresponsive to the first shifting signal in a state where the first device identification is not stored in the first storage device and the second device identification is stored in the first storage device.

With the bicycle component according to the twenty-sixth aspect, the bicycle component cannot be operated in response to receiving the first shifting signal in a state where the first device identification is not stored in the first storage device and the second device identification is stored in the first storage device.

In accordance with a twenty-seventh aspect of the present disclosure, the bicycle component according to any one of the twenty-fourth aspect to the twenty-sixth aspect is configured so that the first signal includes a pairing trigger signal, and the controller is configured to cause the bicycle component to enter a pairing mode in response to the pairing trigger signal in a state where neither the first device identification nor the second device identification is stored in the first storage device.

With the bicycle component according to the twenty-seventh aspect, the pairing process can be easily started in the bicycle component in response to the pairing trigger signal in a state where neither the first device identification nor the second device identification is stored in the first storage device.

In accordance with a twenty-eighth aspect of the present disclosure, the bicycle component according to any one of the twenty-fourth aspect to the twenty-seventh aspect is configured so that the controller is further configured to control the bicycle component in response to the second signal in a state where the second device identification is stored in the first storage device.

With the bicycle component according to the twenty-eighth aspect, the bicycle component can be reliably controlled in response to the second signal in a state where the second device identification is stored in the first storage device.

In accordance with a twenty-ninth aspect of the present disclosure, the bicycle component according to the twenty-eighth aspect is configured so that the controller is further configured to selectively control the bicycle component in response to at least one of the first signal and the second signal in a state where the first device identification and the second device identification are stored in the first storage device.

With the bicycle component according to the twenty-ninth aspect the bicycle component can be reliably controlled by at least two remote devices in a state where the bicycle component can be reliably controlled in response to the second signal in a state where the second device identification is stored in the first storage device stored in the first storage device.

Also, other objects, features, aspects and advantages of the disclosed bicycle component will become apparent to those skilled in the art from the following detailed description, which, taken in conjunction with the annexed drawings, discloses preferred embodiments of the bicycle component.

### BRIEF DESCRIPTION OF THE DRAWINGS

Referring now to the attached drawings which form a part of this original disclosure.

FIG. 1 is a side elevational view of a bicycle that is equipped with a plurality of bicycle components (e.g., a rear derailleur, a first operating device, a drive unit and a second operating device) in accordance with illustrated embodiments of the present disclosure.

FIG. 2 is a diagrammatic view of a bicycle control system including the rear derailleur, the first operating device, the drive unit, the second operating device and a battery of the bicycle illustrated in FIG. 1.

FIG. 3 is an overall schematic block diagram of the bicycle control system illustrated in FIG. 2.

FIG. 4 is a side elevational view of the rear derailleur (i.e., the bicycle component) illustrated in FIGS. 1 to 3.

FIG. 5 is a side elevational view of the first operating device (i.e., the first remote bicycle component) illustrated in FIGS. 1 to 3 for operating the rear derailleur.

FIG. 6 is a side elevational view of the second operating device (i.e., the second remote bicycle component) illustrated in FIGS. 1 to 3 for controlling the drive unit.

FIG. 7 is an overall schematic block diagram of a first modified bicycle control system in accordance with illustrated embodiments of the present disclosure.

FIG. 8 is an overall schematic block diagram of a second modified bicycle control system in accordance with illustrated embodiments of the present disclosure.

FIG. 9 is a flowchart of a control process executed by the controller of the bicycle component (e.g., the rear derailleur).

FIG. 10 is a flowchart of another control process executed by the controller of the bicycle component (e.g., the rear derailleur).

FIG. 11 is a table showing the operation of the bicycle component (e.g., the rear derailleur) in response to a wireless signal based on the device identifications stored in the first storage of the bicycle component (e.g., the rear derailleur) while in the shifting mode.

FIG. 12 is a series of images of a portion of the bicycle component (e.g., the rear derailleur) showing the notifications occurring during the pairing the first operating device and the bicycle component together.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

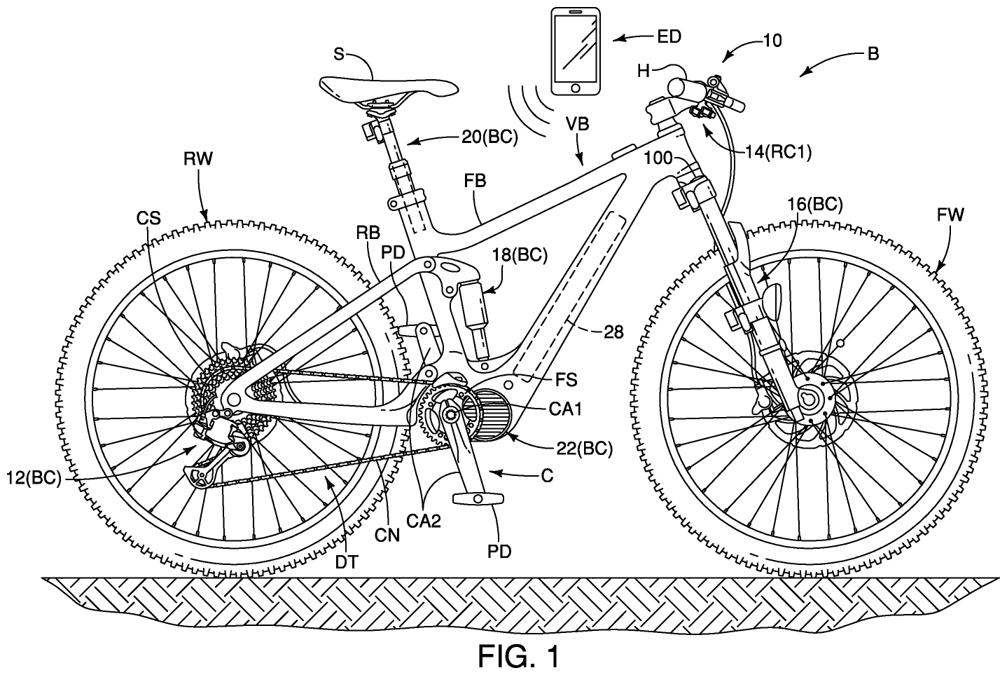

Referring initially to FIG. 1, a bicycle B is illustrated that is equipped with a bicycle control system 10 in accordance with a first embodiment. The bicycle B is illustrated as an e-bike that uses a driving force of an electric motor in addition to a human driving force for propulsion. However, the bicycle control system 10 can be applied to any other type of bicycles such as, for example, a mountain bike, a cyclocross bicycle, a gravel bike, a city bike, a cargo bike, and a recumbent bike. The bicycle B is equipped with a plurality of bicycle component BC. Basically, the bicycle control system 10 is directed to pairing two of the bicycle components BC such that they can wirelessly communicate with each other. Thus, the term “bicycle component BC” as used herein generically refers to all of the bicycle components of the bicycle B that are configured to wirelessly communicate with another one of the bicycle components of the bicycle B after being paired together. The components or parts of the bicycle B that cannot wirelessly communicate will not be referred to as “bicycle component BC” herein.

In the first embodiment, the bicycle B includes a rear derailleur 12 as a bicycle component BC. The bicycle B further includes a first operating device 14 as a bicycle component BC. The first operating device 14 can also be referred to as a first remote component RC1. The first operating device 14 (the first remote component RC1) is configured to wirelessly transmit wireless signals that include each a first device identification ID1 that identifies the source of the wireless signal as coming from the first operating device 14 (the first remote component RC1). In the first embodiment, the first operating device 14 is provided with its own electrical power supply (e.g., one or more rechargeable batteries). The rear derailleur 12 and the first operating device 14 are configured to wirelessly communicate with each other after being paired as explained below. Basically, the first operating device 14 is configured to output wireless signals to the rear derailleur 12 for performing a shifting operation.

As shown in FIG. 1, the bicycle B includes a vehicle body VB that is supported by a rear wheel RW and a front wheel FW. The vehicle body VB basically includes a front frame body FB and a rear frame body RB (a swing arm). The rear derailleur 12 is mounted to the rear frame body RB in a conventional manner. The vehicle body VB is also provided with a handlebar H. The first operating device 14 is preferably configured to be mounted to the handlebar H in a conventional manner. For example, the first operating device 14 is mounted to the right side of the handlebar H adjacent to an inner end of the right hand grip. Here, a front suspension fork 16 is pivotally coupled at its upper end to the front frame body FB, and rotatably supports the front wheel FW at its lower end. The rear frame body RB is swingably mounted to a rear section of the front frame body FB such that the rear frame body RB can pivot with respect to the front frame body FB. The rear wheel RW is mounted to a rear end of the rear frame body RB. A rear shock absorber 18 is operatively disposed between the front frame body FB and rear frame body RB. The rear shock absorber 18 is provided between the front frame body FB and the rear frame body RB to control the movement of the rear frame body RB with respect to the front frame body FB. Namely, the rear shock absorber 18 absorbs shock transmitted from the rear wheel RW. Here, the bicycle B includes the adjustable seatpost 20 is mounted to a seat tube of the front frame body FB in a conventional manner and supports the bicycle seat or saddle S in any suitable manner.

The bicycle B further includes a drivetrain DT. Here, for example, the drivetrain DT is a chain-drive type that includes a crank C, at least one front sprocket FS, a plurality of rear sprockets CS and a chain CN. The crank C includes a crank axle CA1 and a pair of crank arms CA2. The crank axle CA1 is rotatably supported to the front frame body FB via the electric assist unit E. The crank arms CA2 are provided on opposite ends of the crank axle CA1. A pedal PD is rotatably coupled to the distal end of each of the crank arms CA2. While the drivetrain DT is illustrated as a chain-drive type of drivetrain, the drivetrain DT can be selected from any type of drivetrain, and can be a belt-drive type or a shaft-drive type. The front sprocket FS is provided on the crank C to rotate integrally with the crank axle CA1. The rear sprockets CS are provided on a hub of the rear wheel RW. The chain CN runs around the front sprocket FS and the rear sprockets CS. A human driving force is applied to the pedals PD by a rider such that the driving force is transmitted via the front sprocket FS, the chain CN and the rear sprockets CS to the rear wheel RW.

The bicycle B further includes a drive unit 22 as a bicycle component BC. Basically, the drive unit 22 includes an electric motor that is configured to apply a propulsion force to the bicycle B. Here, the crank axle CA1 is integrated into the drive unit 22. The crank axle CA1 is operatively connected to the electric motor of the drive unit 22 such that the crank axle CA1 is rotated by the electric motor of the drive unit 22. Since drive units that assist in the propulsion force of a bicycle are well known in the bicycle, the drive unit 22 will not be discussed in further detail.

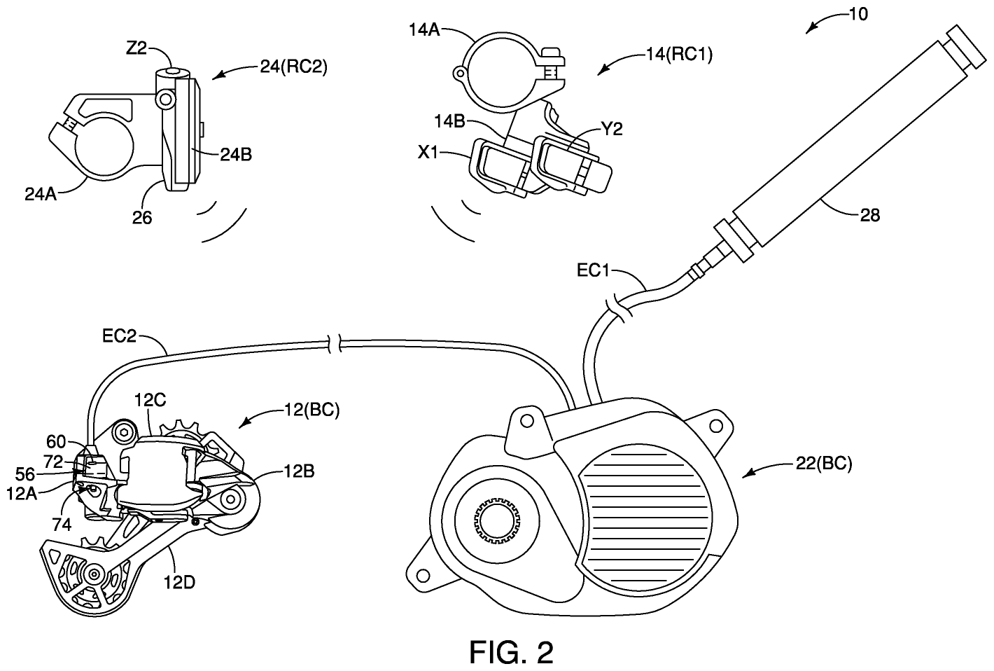

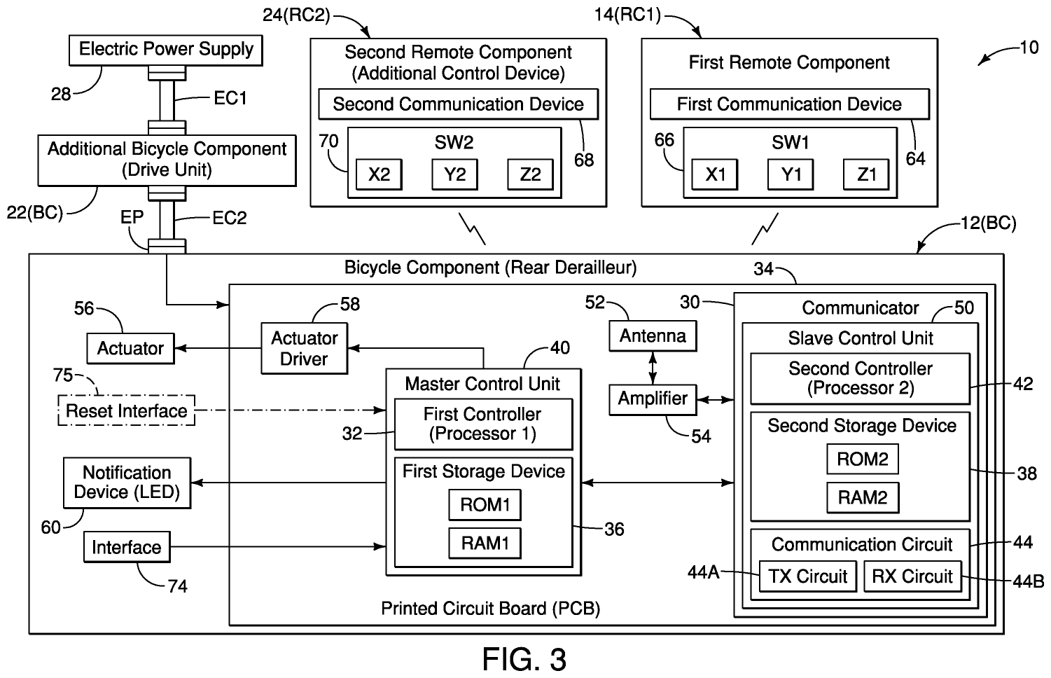

As seen in FIGS. 2 and 3, the bicycle B further includes a second operating device 24 as a bicycle component. The second operating device 24 can also be referred to as a second remote component RC2 or as an additional control device. The second operating device 24 (the second remote component RC2) is configured to wirelessly transmit wireless signals that include each a second device identification ID2 that identifies the source of the wireless signal as coming from the second operating device 24 (the second remote component RC2). In the first embodiment, the second operating device 24 is provided with its own electrical power supply (e.g., one or more rechargeable batteries). Here, the second operating device 24 is integrated to a cycle computer 26. Alternatively, the second operating device 24 can be a separate component from the cycle computer 26.

The second operating device 24 is configured to paired with another bicycle component BC. Preferably, the second operating device 24 is paired with the drive unit 22 so that the drive unit 22 and the second operating device 24 are configured to wirelessly communicate with each other after being paired. Alternatively, the second operating device 24 can be paired with the rear derailleur 12 as explained below.

The second operating device 24 is preferably configured to be mounted to the handlebar H in a conventional manner. For example, the second operating device 24 is mounted to the left side of the handlebar H adjacent to an inner end of the left hand grip. Here, the second operating device 24 is integrated to a cycle computer 26. Alternatively, the second operating device 24 can be a separate component from the cycle computer 26.

Basically, in the case where the drive unit 22 and the second operating device 24 are paired, the second operating device 24 is configured to output wireless signals to the drive unit 22 for changing an operating mode of the drive unit 22. The operating modes include, for example, a high assist mode, a normal assist mode, an eco assist mode, a walk assist mode and an off mode. The high assist mode is an assist mode that provides a greater assist power than at the normal assist mode within a predetermined speed range. The eco assist mode is an assist mode that provides a lower assist power than at normal assist mode within a predetermined speed range. The walk assist mode is an assist mode that drives the motor of the drive unit 22 such that the bicycle B travels at a predetermined speed for a user to walk beside the bicycle B at a comfortable walking speed.

The rear derailleur 12 (i.e., a bicycle component) is configured to shift the chain CN between the rear sprockets CS in response to either an automatic shift signal from the cycle computer, or a user inputted shift signal from the first operating device 14.

The bicycle B further includes an electrical power supply 28. Here, the electrical power supply 28 is a battery pack that includes one or more batteries. As illustrated in FIG. 1, the power supply 28 is located in the downtube of the bicycle frame. Alternatively, the power supply 28 can be attached an outer surface of the bicycle frame. The electrical power supply 28 preferably includes one or more rechargeable batteries. The electrical power supply 28 is configured to supply electrical power to the drive unit 22 and the rear derailleur 12. In particular, as seen in FIG. 2, the drive unit 22 is electrically connected to the electrical power supply 28 by a first electrical cable EC1. The rear derailleur 12 is electrically connected to an electrical junction of the drive unit 22 by a second electrical cable EC2. In other words, here, the rear derailleur 12 receives electrical power from the power supply 28 via the drive unit 22. Alternatively, the rear derailleur 12 can be directly connected to the power supply 28 to receive the electrical power directly from the power supply 28. When the drive unit is in the off mode, the electrical power from the power supply 28 is disconnected from the rear derailleur 12. Thus, when the drive unit 22 is turned on, the electrical power from the power supply 28 is supplied to the rear derailleur 12. Preferably, the first electrical cable EC1 and the second electrical cable EC2 have pluggable electrical connectors provided at one or both ends for easy connection and disconnection. Also, alternatively, the first electrical cable EC1 and/or the second electrical cable EC2 can be power line communication (PLC) cables as needed and/or desired. Here, the rear derailleur 12 has a power source connection EP. Basically, the rear derailleur 12 comprises the communicator 30, the controller 32 and the electrical power connection EP. The power source connection EP is configured to be connected to the power supply 28 to receive electrical power from the power supply 28. Here, the power source connection EP is an electrical cable connection that receives the electrical connector of the second electrical cable EC2. Alternatively, the power source connection EP includes at least one of battery connection.

In the first embodiment, the second operating device 24 is provided with its own electrical power supply (e.g., one or more rechargeable batteries) and wirelessly communicates with the drive unit 22. Alternatively, the electrical power supply 28 can be connected to the second operating device 24 by an electrical cable, and can communicates with the drive unit 22 via the electrical cable.

Referring now to FIG. 3, an overall schematic block diagram of the bicycle control system 10 illustrated in FIG. 2. Basically, the bicycle control system 10 comprises a bicycle component BC and a first remote component RC1 (e.g., the first operating device 14). As seen in FIG. 3, the rear derailleur 12 is illustrated as the bicycle component BC. However, as mentioned above, the configuration shown in FIG. 3 is not limited to the rear derailleur 12. Rather, the other bicycle component BC can include this same configuration illustrated in FIG. 3. Here, the bicycle control system 10 includes the rear derailleur 12, the first operating device 14, the drive unit 22, the second operating device 24, the cycle computer 26 and the power supply 28.

The bicycle component BC basically comprises a communicator 30 and a controller 32. In other words, in the first embodiment, the rear derailleur 12 comprises the communicator 30 and the controller 32. Here, the communicator 30 and the controller 32 are provided on a printed circuit board 34. Thus, the communicator 30 and the controller 32 are electrically connected via the printed circuit board 34. Also, the bicycle component BC basically comprises the power source connection EP, the communicator 30 and the controller 32.

The bicycle component BC further comprises a first storage device 36. As explained below, the first storage device 36 preferably includes non-volatile memory. The first storage device 36 is configured to store at least one of device identifications including a first device identification ID1 and a second device identification ID2. The bicycle component BC further comprises a second storage device 38. The second storage device 38 preferably includes volatile memory as explained below. Here, the first storage device 36 is also provided on the printed circuit board 34, and is electrically connected to the controller 32 via the printed circuit board 34. Here, the controller 32 and the first storage device 36 are part of the circuitry forming a master control unit 40 of the bicycle component BC. The controller 32 can also be referred to as a first controller or a master controller. The second storage device 38 is also provided on the printed circuit board 34. Here, the second storage device 38 is a part of the circuitry forming the communicator 30.

The communicator 30 is a wireless communicator that is configured to at least receive wireless signals. Here, the communicator 30 is a wireless communicator that is configured to both receive and transmit wireless signals. The term “communicator” as used herein refers to hardware that transmits signals, and does not include a human being. The term “communicator” includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. The wireless communication signals can be radio frequency (RF) signals, ultra-wide band communication signals, radio frequency identification (RFID), ANT+ communications, or Bluetooth® communications, an original wireless communication standard, or any other type of signal suitable for short range wireless communications as understood in the bicycle field. Here, the communicator 30 is a two-way wireless communicator such as a transceiver or a transmitter-receiver. However, alternatively, the communicator 30 can be a one-way wireless communicator such as a receiver.

Basically, the controller 32 is an electronic controller that includes at least one processor that is configured to execute predetermined control program (e.g., a pairing program, a shifting program, etc). The processor includes, for example, a central processing unit (CPU) or a micro processing unit (MPU). Thus, the terms “controller” and “electronic controller” as used herein refer to hardware that executes a software program, and does not include a human being. The controller 32 is actuated by electrical power supplied from the electrical power supply 28. Basically, as explained below, the controller 32 is configured to establish wireless communication between the bicycle component BC and a remote communication device in response to a pairing demand signal being received by the communicator 30 in a state where the bicycle component BC is in a pairing mode as explained below. Also, as explained below, the controller 32 is configured to change a mode of the bicycle component BC to a wireless signal listening mode in response to electric power being received from the power source 28 through the power source connection.

Here, in the first embodiment, the communicator 30 includes a controller 42. The controller 42 can also be referred to as a second controller or a slave controller. The controller 42 is an electronic controller that includes at least one processor that is configured to control a communication circuit 44 such as a radio-frequency integrated circuit. The communication circuit 44 includes a signal transmitting circuit 44A (TX circuit) and a signal receiving circuit 44B (RX circuit). The processor 42A includes, for example, a central processing unit (CPU) or a micro processing unit (MPU). The controller 42 is actuated by electrical power supplied from the electrical power supply 28. The controller 42 and the radio-frequency integrated circuit 44 are provided on the printed circuit board 34. Here, the second storage device 38, the controller 42 and the radio-frequency integrated circuit 44 are part of the circuitry forming a slave control unit 50 of the bicycle component BC. Thus, the controller 42 is subordinate to the controller 32. The controller 42 could be omitted such that the functions of the controller 42 are carried out by the controller 32.

Here, for example, the first storage device 36 includes, for example, at least one of a read-only memory (ROM), an erasable programmable read only memory (EPROM), an electrically erasable programmable read-only memory (EEPROM), and a flash memory. The first storage device 36 stores various control processes or control programs as well as information or data used by the controller 32. Here, the first storage device 36 includes, for example, a first non-volatile memory ROM1 and a first volatile memory RAM1. The first non-volatile memory ROM1 is preferably flash memory. The first volatile memory RAM1 includes, for example, a random access memory (RAM).

Here, for example, the second storage device 38 includes, for example, at least one of a read-only memory (ROM), an erasable programmable read only memory (EPROM), an electrically erasable programmable read-only memory (EEPROM), and a flash memory. The second storage device 38 stores various control processes or control programs for the communicator 30 as well as information or data used by the communicator 30. Here, the second storage device 38 includes, for example, a second non-volatile memory ROM2 and a second volatile memory RAM2. The second non-volatile memory ROM2 is preferably flash memory. The second volatile memory RAM2 includes, for example, a random access memory (RAM). The second storage device 38 could be omitted such that all programs and information is stored in the first storage device 36.

The bicycle component BC further comprises an antenna 52 coupled to the communicator 30. The antenna 52 is configured to receive and transmit signals from the communicator 30. Here, the bicycle component BC further comprises a signal amplifier 54 coupled to the communicator 30. The signal amplifier 54 is provided for selectively amplifying the signals of the antenna 52. The signal amplifier 54 can be controlled by either the controller 32 or the controller 42. The controller 32 is configured to control the signal amplifier 54 such that the signal amplifier 54 operates in a first power consumption state in a state where the bicycle component BC is in a wireless signal listening mode. The controller 32 is configured to control the signal amplifier 54 such that the signal amplifier 54 operates in a second power consumption state in a state where the bicycle component BC is in a pairing mode. The first power consumption state has a lower power consumption than the second power consumption state. For example, the signal amplifier 54 operates intermittently, sleeps or turns off in the first power consumption state where the bicycle component BC is in the wireless signal listening mode. In this way, the communicator 30 is less likely incorrectly paired by reducing the signal strength where the bicycle component BC is in the pairing mode. On the other hand, in all other modes, the signal amplifier 54 is operated at full strength to ensure receiving a control signal.

In the case of the rear derailleur 12 as the bicycle component BC, the bicycle component BC further comprises an actuator 56. Here, the actuator 56 of the rear derailleur 12 is a reversible electric motor. The actuator 56 is controlled by the controller 32 via an actuator driver 58. The actuator driver 58 is provided on the printed circuit board 34. The actuator 56 is operated by the controller 32 in response to a shift signal being received by the communicator 30 while the rear derailleur 12 is in the shifting mode. The shift signal can be either an automatic shift signal generated by the cycle computer 26 based on one or more operation conditions of the bicycle B, or a user inputted shift signal generated by the first operating device 14 based on a user input. Thus, the rear derailleur 12 (i.e., a bicycle component) is configured to shift the chain CN between the rear sprockets CS in response to either an automatic shift signal from the cycle computer 26, or a user inputted shift signal from the first operating device 14.

The bicycle component BC further comprises a notification device 60 being configured to be controlled by the controller 32. Here, the notification device 60 includes a light emitting device. For example, the notification device 60 includes one or more light emitting diodes (LEDs). Here, the notification device 60 includes a red LED, a blue LED and a green LED that can be selectively illuminated by the controller 32 to produce different colors of light. In other words, the controller 32 controls the notification device 60 to selectively illuminate the LEDs of the notification device 60 to produce a notification (e.g., a solid continuous light or a flashing light of a predetermined color) to indicate a particular situation is occurring or has been completed.

As mentioned above, the first operating device 14 and the second operating device 24 are configured to generate wireless signals. As seen in FIG. 3, the first operating device 14 includes a first communication device 64 and a first input device 66 having a plurality of first user interfaces X1, Y1 and Z1, which can each also be simply referred to as a first interface. Similarly, the second operating device 24 includes a second communication device 68 and a second input device 70 having a plurality of second user interfaces X2, Y2 and Z2, which can each also be simply referred to as a second interface. The first communication device 64 and the second communication device 68 are wireless communicators that have the same configuration as the communicator 30 but with the receiver circuit omitted. Alternatively, the first communication device 64 and the second communication device 68 can have the same configuration as the communicator 30. Each of the first user interfaces X1, Y1 and Z1 and the second user interfaces X2, Y2 and Z2 generate an electrical signal when operated. For example, the first user interfaces X1, Y1 and Z1 and the second user interfaces X2, Y2 and Z2 are switches that close or open a circuit to generate an electrical signal. Moreover, preferably, each of the first operating device 14 and the second operating device 24 are provided with a signal amplifier and an antenna for transmitting the wireless signals.

The electrical signals generated by the operations of one or more of the first user interfaces X1, Y1 and Z1 are received by the controller of the first communication device 64. The controller of the first communication device 64 outputs a wireless signal via the transmitter circuit of the first communication device 64 in accordance with the operation of one or more of the first user interfaces X1, Y1 and Z1. Each of the wireless signals generated by the first communication device 64 includes a first device identification ID1, which identifies the wireless signal as being generated by the first communication device 64. In this way, the controller 32 can determine the source of the wireless signal generated by the first communication device 64.

Similarly, the electrical signals generated by the operations of one or more of the second user interfaces X2, Y2 and Z2 are received by the controller of the second communication device 68. The controller of the second communication device 68 outputs a wireless signal via the transmitter circuit of the second communication device 68 in accordance with the operation of one or more of the second user interfaces X2, Y2 and Z2. Each of the wireless signals generated by the second communication device 68 includes a second device identification ID2, which identifies the wireless signal as being generated by the second communication device 68. In this way, the controller 32 can determine the source of the wireless signal generated by the second communication device 68. The first operating device 14 can be referred to a first remote component and the second operating device 24 can be referred to a second remote component. Moreover, either one of the first operating device 14 and the second operating device 24 can be used as a trigger input device for starting a pairing operation between the rear derailleur 12 and the first operating device 14 as explained below. Moreover, in the first embodiment, anyone of the bicycle component BC having a user interface can be used for starting a pairing operation between the rear derailleur 12 and the first operating device 14. However, once the rear derailleur 12 has entered the pairing mode, the first operating device 14 is used as a first input device for generating a first pairing demand signal in response to a first user input of the first operating device 14 (i.e., the first input device in this example). The first pairing demand signal can be received by the communicator 30 of the rear derailleur 12 during the pairing mode of the pairing process discussed below. The first device identification ID1 is included in the first pairing demand signal that is received by the communicator 30. In this way, the wireless signals from the first communication device 64 of the first operating device 14 can be identified by the controller 32 of the rear derailleur 12. Likewise, the second pairing demand signal can be received by the communicator 30 of the rear derailleur 12 during the pairing mode of the pairing process discussed below. The second device identification ID2 is included in the second pairing demand signal that is received by the communicator 30. In this way, the wireless signals from the second communication device 68 of the second operating device 24 can be identified by the controller 32 of the rear derailleur 12.

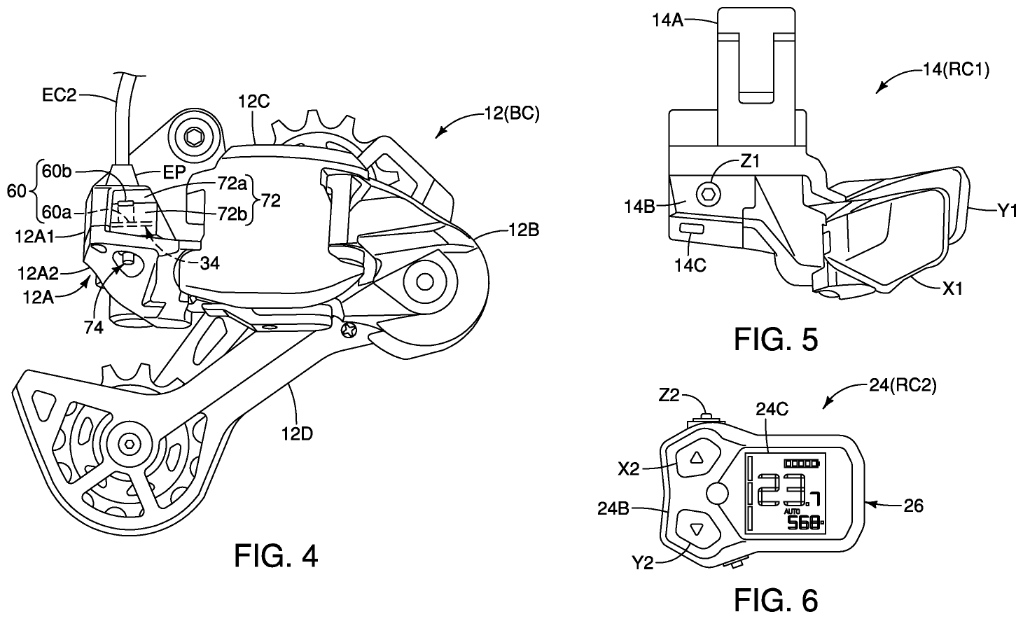

Referring now to FIG. 4, an example of the rear derailleur 12 is illustrated. The rear derailleur 12 basically comprises a base member 12A, a movable member 12B, and a linkage 12C. The movable member 12B is provided with a chain guide 12D. Since electric derailleurs are well known in the bicycle field, the base member 12A, the movable member 12B, the linkage 12C and the chain guide 12D will not be discussed in detail for the sake of brevity. Here, the actuator 56 is provided on the base member 12A, and is operatively coupled to the linkage 12C. The communicator 30 and the controller 32 are provided to the base member 12A for controlling the actuator 56.

The notification device 60 is provided to the base member 12A. Preferably, the notification device 60 is provided to an actuation unit housing 72 that housings the communicator 30, the controller 32, the printed circuit board 34 and the actuator 56. Here, the base member 12A includes a first base part 12A1 and a second base part 12A2. The first base part 12A1 and the second base part 12A2 are coupled together by fasteners such as screws. The actuation unit housing 72 is disposed between the first base part 12A1 and the second base part 12A2.

The notification device 60 is preferably visible through a transparent window portion of the actuation unit housing 72. In one example, the notification device 60 includes a light emitter 60a and a light transmission member 60b. The light emitter 60a is configured to emit light. The light emitter 60a is configured to be electrically connected to the circuit board 34, which is provided in the actuation unit housing 72. The light transmission member 60b is configured to transmit light emitted from the light emitter 60a. The light transmission member 60b includes the transparent window portion of the actuation unit housing 72 such that the light produced by the light emitter 60a is visible to a user. The light transmission member 60b can include one or more pieces for transmitting the light emitted from the light emitter 60a to outside of the actuation unit housing 72.

The actuation unit housing 72 is provided in the base member 12A such that the transparent window portion of the actuation unit housing 72 (a part of the light transmission member 60b) is exposed through an opening formed between the first base part 12A1 and the second base part 12A2. The actuation unit housing 72 includes a first part 72a and the second part 72b. A first opening is provided between the first part 72a and the second part 72b. The light transmission member 60b is provided on the first wall of the actuation unit housing 72. The transparent window portion of the light transmission member 60b has rectangular shape. The light transmission member 60b is exposed from the first opening in the actuation unit housing 72. The first wall is, for example, a side wall of the actuation unit housing 72. Preferably, the first wall is located on an outer side of the actuation unit housing 72 in a state where the rear derailleur 12 is mounted on the bicycle frame. The outer side of the actuation unit housing 72 as used herein refers to the side of the actuation unit housing 72 that is further from the bicycle center plane in a state where the rear derailleur 12 is mounted on the bicycle frame. Accordingly, here, the first wall of the actuation unit housing 72 is further from the bicycle center plane than the printed circuit board 34 in a state where the rear derailleur 12 is mounted on the bicycle frame in an upright orientation. In other words, the outer side of the actuation unit housing 72 is further from the bicycle center plane than the printed circuit board 34 in a state where the rear derailleur 12 is mounted on the bicycle frame in an upright orientation.

The rear derailleur 12 is preferably provided with an interface 74 for the user to control the pairing process discussed below. In the first illustrated embodiment, the interface 74 corresponds to the third input device. The third input device constitutes an exit interface and/or a reset interface in the first illustrated embodiment. As explained below, the controller 32 is configured to cause the bicycle component BC to exit the pairing mode in response to a third user input of the third input device (e.g., the interface 74). Preferably, the third input device (e.g., the interface 74) is provided on at least one of the bicycle component BC and the first remote component RC1. Here, the third input device (e.g., the interface 74) is provided to the bicycle component BC (e.g., the rear derailleur 12). However, the third input device can be provided on the second remote component RC2. For example, the interface 74 can be a button that is operatively connected to the controller 32 via the printed circuit board 34. The interface 74 is connected to a first surface of the printed circuit board 34. On the other hand, the light emitter 60a is connected to a second surface of the printed circuit board. The second surface is the opposite side of the printed circuit board 34 from the first surface. In the case where the interface 74 is a button, different operations can be performed based on how the button is operated. For example, the interface 74 can be used to exit the pairing mode. Furthermore, the interface 74 can be used to confirm that the pairing process has been completed.

Preferably, the interface 74 is provided to the actuation unit housing 72 so that the interface 74 can be easily operated by a user. Here, the interface 74 is provided on a second wall of the actuation unit housing 72. The second wall is a bottom wall of the second part 72b of the actuation unit housing 72. The second wall is located bottom side of the actuation unit housing 72 in a state where the rear derailleur 12 is mounted on the bicycle frame. The bottom side of the actuation unit housing 72 as used herein refers to a lower side of the actuation unit housing 72 with respect to a vertical direction in a state where the rear derailleur 12 is mounted on the bicycle frame in an upright orientation. Thus, the bottom side of the actuation unit housing 72 can also be referred to as lower side. In other words, here, the second wall is located on a lower side that is lower than the printed circuit board 34 with respect to a vertical direction in a state where the rear derailleur 12 is mounted on the bicycle frame in an upright orientation. The interface 74 is exposed from a second opening which is provided the second part 72b of the actuation unit housing 72. Here, the interface 74 is a button that is exposed from an opening in the second base part 12A2 of the base member 12A. In this way, the user can easily operate the interface 74.

Preferably, the rear derailleur 12 can be reset such that the pairing data (e.g., the device identifications) stored in the first non-volatile memory ROM1 of the first storage device 36 is erased using an external device ED. More specifically, the controller 32 is configured to clear the device identification stored in the first non-volatile memory ROM1 of the first storage device 36 in response to a reset operation of using the external device ED. The external device ED can be a smartphone, a tablet or some other device having a wireless communication device that can communicate with the communicator 30. The external device ED can be used to set a pass code using software (application) in the external device ED. When a pass code is set, a user cannot enable reset operation without using the pass code. In the case where the external device ED is a smartphone as seen in FIG. 1, or a tablet, the reset interface of the external device ED can be the touch screen. Alternatively, the rear derailleur 12 (i.e., the bicycle component BC) further comprises a reset interface 75 (shown in a dash-dot line) operatively coupled to the controller 32. For example, the reset interface 75 can be a button that can be operated by a user. Alternatively, the reset interface 75 is configured to be pressed by using a tool. The reset interface 75 is operatively coupled to the controller 32. In this way, the controller 32 is configured to execute a reset operation in response to a reset operation of the reset interface 75. Thus, the controller 32 is configured to clear the device identification stored in the first storage device 36 in response to a reset operation of a reset interface. Also, the controller 32 is configured to disable the reset operation upon a command from the external device ED. Alternatively, the interface 74 can function as the reset interface. In this case, the interface 74 functions as both a reset interface and an exit interface. In this case, the controller 32 is configured to execute a reset operation in response to a reset operation of the interface 74.

The base member 12A is configured to be attached to the rear frame body RB of the bicycle B. The movable member 12B is movable relative to the base member 12A. Specifically, the linkage 12C movably connects the movable member 12B to the base member 12A. The actuator 56 is configured to move the movable member 12B relative to the base member 12A in response to a shifting operation. Here, as mentioned above, the actuator 56 is a reversible electric motor. The shifting operation can be a manual shifting operation in which the first operating device 14 or some other operating device is operated to generate a shift signal that is transmitted to the actuator 56 to operate the bicycle derailleur 10A. The shifting operation can also be an automatic shifting operation in which a shift signal is generate by a controller of the cycle computer 26 based on one or more operating conditions of the bicycle B.

Referring now to FIGS. 2 and 5, an example of the first operating device 14 is illustrated. As mentioned above, after pairing, the first operating device 14 is configured to operate the rear derailleur 12. The first operating device 14 has a mounting portion 14A and a housing portion 14B. The mounting portion 14A is configured to be attached to the handlebar of the bicycle B. The housing portion 14B is attached to the mounting portion 14A. The housing portion 14B housings the electrical components of the first operating device 14 as explained below. Here, the first operating device 14 further includes a notification device 14C for notifying a user of various states or events related to the first operating device 14.

The first user interfaces X1 and Y1 are levers that is pivotally mounted to the housing portion 14B, while the first user interface Z1 is a push button. The first operating device 14 is not limited to this illustrated configuration. For example, the first operating device 14 can include less than three user interfaces or more than three user interfaces. Also, for example, the user interfaces of the first operating device 14 can be all push buttons or all levers, or any combination thereof. Moreover, for example, the user interfaces of the first operating device 14 include one or more touch screens, dials, etc. Here, the first user interface X1 is used for upshifting the rear derailleur 12 and the first user interface Y1 is used for downshifting the rear derailleur 12. The first user interface Z1 is used for changing the shifting modes (e.g., manual shifting mode or automatic shifting mode).

Here, the notification device 14C includes one or more light emitting devices such as one or more LEDs for notifying a user of various states or events related to the first operating device 14. An LED of the notification device 14C can be illuminated each time one of the first user interfaces X1, Y1 and Z1 is operated and/or when wireless signal is received by the first operating device 14.

Referring now to FIGS. 2 and 6, an example of the second operating device 24 is illustrated. As mentioned above, after pairing, the second operating device 24 is configured to control the drive unit 22. The second operating device 24 has a mounting portion 24A and a housing portion 24B. The mounting portion 24A is configured to be attached to the handlebar of the bicycle B. The housing portion 24B is attached to the mounting portion 24A, and housings the electrical components of the second operating device 24. The second user interfaces X2, Y2 and Z2 are push buttons. The second operating device 24 is not limited to this illustrated configuration. For example, the second operating device 24 can include less than three user interfaces or more than three user interfaces for controlling the drive unit 22. Also, for example, the user interfaces of the second operating device 24 can be all push buttons or all levers, or any combination thereof. Moreover, for example, the user interfaces of the second operating device 24 include one or more touch screens, dials, etc. Here, the second user interfaces X2 and Y2 are used for changing the assist mode of the drive unit 22 where the second user interface X2 scrolls upward through the assist modes and the second user interface Y2 moves downward through the assist modes. The second user interface Z2 is a on/off power switch used for turning the drive unit 22 on and off.

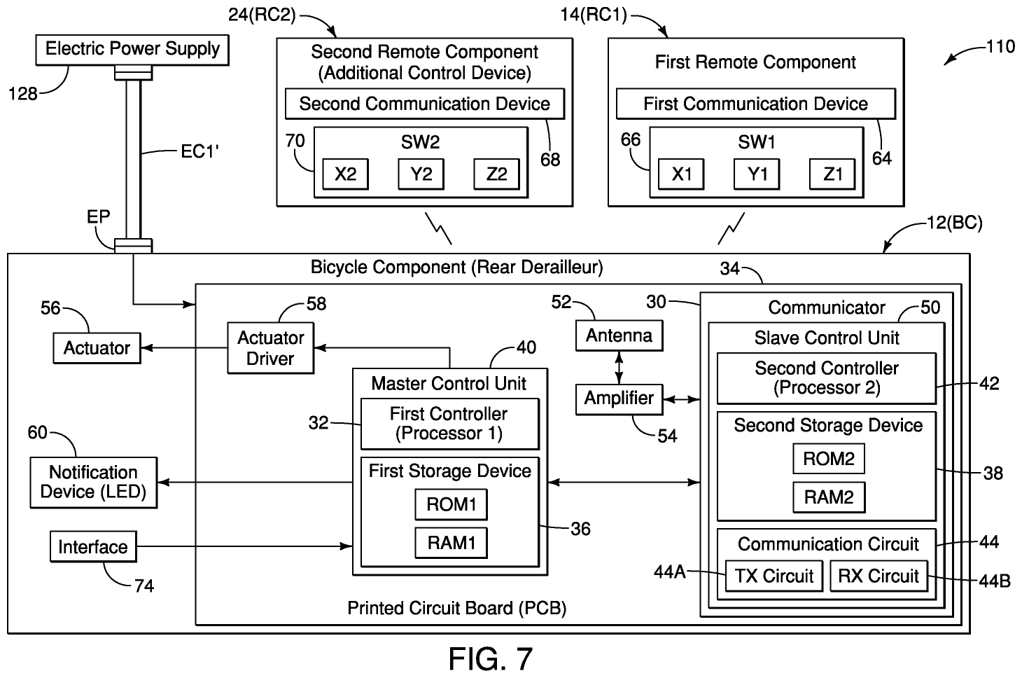

Referring now to FIG. 7, a bicycle control system 110 is schematically illustrated in accordance with a first modification. Basically, the bicycle control system 110 is identical the bicycle control system 10, except that an electrical power supply 128 is directly connected to the rear derailleur 12 (i.e., the bicycle component) by a first electrical cable EC1′. In view of the similarity between the bicycle control system 10 and the bicycle control system 110, the parts of the bicycle control system 110 that are identical to the parts of the bicycle control system 10 will be given the same reference numerals as the parts of the bicycle control system 10. Moreover, the descriptions of the parts of the bicycle control system 110 that are identical to the parts of the bicycle control system 10 may be omitted for the sake of brevity.

Basically, the rear derailleur 12 comprises the communicator 30, the controller 32 and the power source connection EP. The power source connection EP is configured to be connected to the electrical power supply 128 to receive electric power from the electrical power supply 128. The electrical power supply 128 can be provided in the downtube of the front frame body FB as in the first embodiment. Alternatively, the electrical power supply 128 can be provided to any other suitable part of the bicycle frame. Here, the electrical power supply 128 is a battery pack that includes one or more batteries. The electrical power supply 128 can be configured to supply electrical power to both the rear derailleur 12 (i.e., the bicycle component) and at least one other component of the bicycle. For example, the electrical power supply 128 can be provided in the seat tube of the bicycle B and configured to supply electrical power to the adjustable seatpost 20 and the rear derailleur 12. The electrical power supply 128 can be integrated into the other component such as the adjustable seatpost 20. Moreover, the electrical power supply 128 can also provide electrical power to one or more bicycle components other than the adjustable seatpost 20 such as, for example, a front derailleur, a drive unit and/or a suspension.

Alternatively, the electrical power supply 128 can be a standalone battery pack that is mounted to part of another component of the bicycle and solely supplies electrical power to the rear derailleur 12 (i.e., the bicycle component). Preferably, the electrical cable EC2 has a pluggable electrical connector provided at one or both ends for easy connection and disconnection.

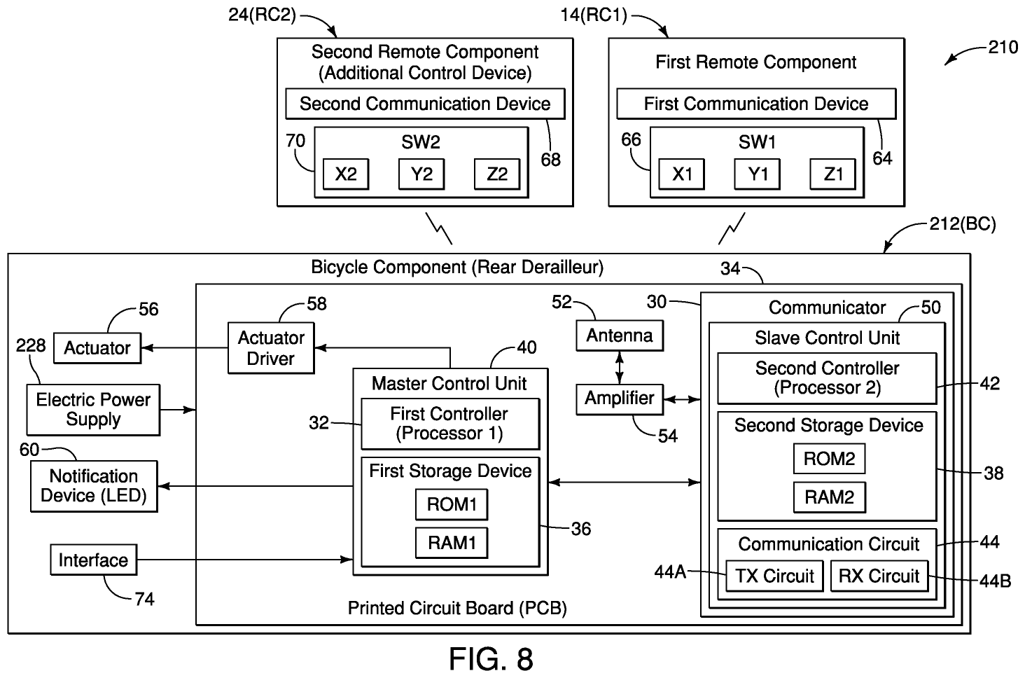

Referring now to FIG. 8, a bicycle control system 210 is schematically illustrated in accordance with a first modification. Basically, the bicycle control system 210 is identical the bicycle control system 10, except that an electrical power supply 228 is provided to a rear derailleur 212. The rear derailleur 212 is identical to the rear derailleur 212 except that the rear derailleur 212 is configured to support the electrical power supply 228 and has a battery connection for electrically connecting the electrical power supply 228. In view of the similarity between the bicycle control system 10 and the bicycle control system 210, the parts of the bicycle control system 210 that are identical to the parts of the bicycle control system 10 will be given the same reference numerals as the parts of the bicycle control system 10. Moreover, the descriptions of the parts of the bicycle control system 210 that are identical to the parts of the bicycle control system 10 may be omitted for the sake of brevity.

Basically, the rear derailleur 212 comprises the communicator 30, the controller 32 and the electrical power supply 228. Here, the electrical power supply 228 is a battery pack that includes one or more batteries. The electrical power supply 228 preferably includes one or more rechargeable batteries. The electrical power supply 228 is mounted to one of the base member 12A, the movable member 12B, and the linkage 12C where the bicycle component BC is the rear derailleur 12. In any case, the electrical power supply 228 is configured to supply electrical to the electrical parts of the bicycle component BC. For example, the electrical power supply 228 is electrically connected to the printed circuit board 34. Here, the electrical power supply 228 is detachably and reattachably installed to the bicycle component BC (the rear derailleur 12). For example, the electrical power supply 228 can have exposed electrical contacts directly contact electrical terminals electrically connected to the printed circuit board 34. Thus, for example, the electrical power supply 228 can be configured to be inserted into a cavity having the electrical terminals of the printed circuit board 34, and then retained in the cavity to establish the electrical connection between the electrical power supply 228 and the printed circuit board 34. Alternatively, the printed circuit board 34 or the electrical power supply 228 can have an electrical cable with a first electrical connector that is configured to mate with a second electrical connector of the other one of the printed circuit board 34 or the electrical power supply 228.

While the present disclosure focused on the pairing of the rear derailleur 12 (the bicycle component) and the first operating device 14, the pairing process can be applied to any other two bicycle components equipped with wireless communications. For example, the rear shock absorber 18 can be provided with a wireless communicator that is paired with a wireless communicator of a rear suspension control device so that the rear suspension control device can wireless communicates with the rear shock absorber 18 to adjust settings of the rear shock absorber 18. Likewise, for example, the front suspension fork 16 can be provided with a wireless communicator that is paired with a wireless communicator of a front suspension control device so that the front suspension control device can wireless communicate with the front suspension fork 16 to adjust settings of the front suspension fork 16. Moreover, for example, the seatpost 20 can be provided with a wireless communicator that is paired with a wireless communicator of a seatpost control device so that the seatpost control device can wireless communicate with the seatpost 20 to adjust settings of the seatpost 20. Furthermore, for example, the seatpost 20 can be provided with a wireless communicator that is paired with a wireless communicator of a seatpost control device so that the seatpost control device can wireless communicate with the seatpost 20 to adjust settings of the seatpost 20. In addition, for example, the drive unit 22 can be provided with a wireless communicator that is paired with a wireless communicator of a control device so that such a control device can wireless communicate with the drive unit 22 to adjust settings of the drive unit 22.

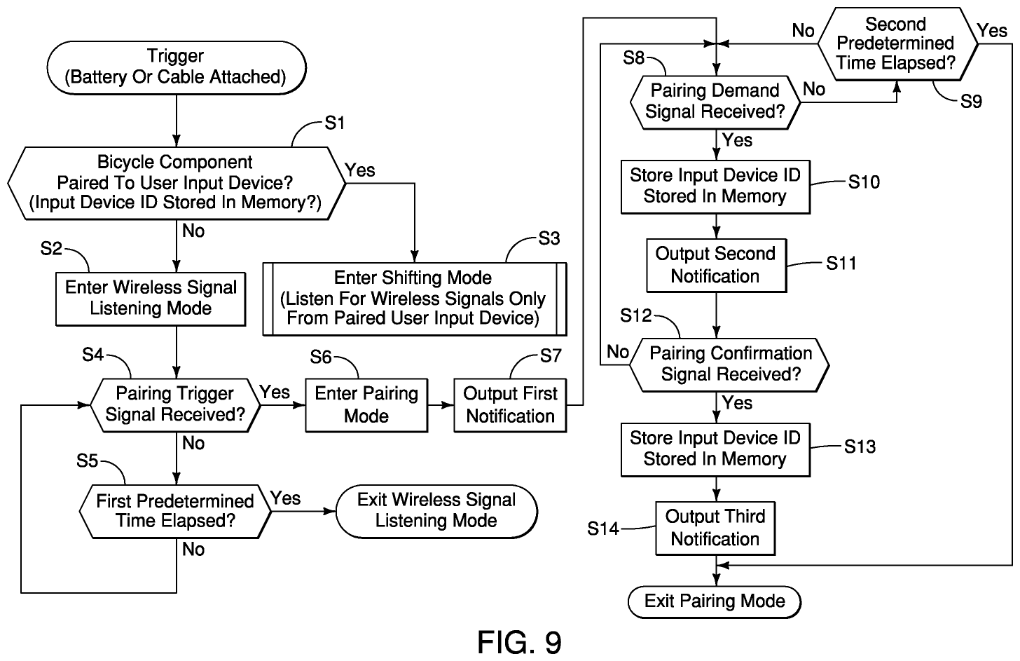

Referring now to FIG. 9, a control process executed by the controller 32 will now be discussed for pairing a bicycle component BC (e.g., the rear derailleur 12) to another bicycle component BC (e.g., the first operating device 14). During the control process, the controller 32 controls the controller 42 such that the controller 32 functions as the master controller and the controller 42 functions as the slave controller. The control process of FIG. 9 can be used in each of the bicycle control systems 10, 110 and 210.

In this control process, the bicycle component BC (e.g., the rear derailleur 12) starts when a triggering event occurs. In other words, the bicycle component BC is configured to enter a wireless signal listening mode in response to a trigger. Here, the trigger is when the bicycle component BC receives electrical power. For example, the trigger includes at least one of providing electrical power to the bicycle component BC, connecting a power source to the bicycle component BC, connecting an electrical cable connected to an additional bicycle component, and operating an additional control device configured to control the additional bicycle component BC. For example, in one case, the trigger can occur when a battery is attached to the bicycle component BC either directly or indirectly such that the electrical power is provided to the bicycle component BC.

In another case, for example, the trigger can occur when the second electrical cable EC2 is connected to the drive unit 22 (i.e., the additional bicycle component) and then connected to the rear derailleur 12 (i.e., the bicycle component BC). In another case, for example, the trigger can occur when the second user interface Z3 (i.e., the additional control device) is operated to turn on (i.e., supply power from the power supply 28) the drive unit 22 (i.e., the additional bicycle component).

In any case, in the illustrated embodiments, the notification device 60 is not activated (e.g., an LED is not illuminated) when the bicycle component BC receives electrical power. Now, once the bicycle component BC receives electrical power, the controller 32 proceeds to step S1.

In step S1, the controller 32 first determines if the bicycle component BC has already been paired to a remote component (e.g., an operating device such as the first operating device 14). In particular, after the power is supplied to the bicycle component BC, the controller 32 read the first non-volatile memory ROM1 of the first storage device 36 to determine if a device identification ID of a remote component (e.g., an operating device such as the first operating device 14) is stored in the first non-volatile memory ROM1 of the first storage device 36. If the bicycle component BC is not paired to a remote component (e.g., an operating device such as the first operating device 14), then the controller 32 proceeds to step S2 where the controller 32 controls the communicator 30 to enter the wireless signal listening mode. In other words, if a device identification ID of a remote component (e.g., an operating device such as the first operating device 14) is not already stored in the first non-volatile memory ROM1 of the first storage device 36, then the controller 32 controls the communicator 30 such that the bicycle component BC enters into the wireless signal listening mode. On the other hand, if the bicycle component BC is paired to a remote component (e.g., an operating device such as the first operating device 14), then the controller 32 proceeds to step S3 where the controller 32 controls the communicator 30 to enter the shifting mode and the control process ends. In other words, if a device identification ID of a remote component (e.g., an operating device such as the first operating device 14) is already stored in the first non-volatile memory ROM1 of the first storage device 36, then the controller 32 controls the communicator 30 such that the bicycle component BC enters into the shifting mode. Accordingly, the controller 32 is configured to prohibit the bicycle component BC from entering the wireless signal listening mode in a state where wireless communication between the bicycle component BC and the first remote component is established.

In step S2, the controller 32 controls the communicator 30 to enter the wireless signal listening mode. In the wireless signal listening mode, the communicator 30 monitors or listens for all wireless signals from all types of bicycle components that can transmit a wireless signal according to the wireless protocol of the bicycle component BC. Thus, the phrase “wireless signal listening mode” refers to a mode where the bicycle component BC has not completed a pairing operation. The communicator 30 is configured to wirelessly receive a first signal including the first device identification ID1 generated from the first communication device 64 and a second signal including the second device identification ID2 generated from the second communication device 68.

The first signal includes one of a first shifting signal and a first pairing trigger signal. In the embodiment, the first shifting signal is different from the first pairing trigger signal. For example, the first shifting signal is generated in response to a user individually operating to the first user interfaces X1 and Y1 and the first pairing trigger signal is generated in response to a user simultaneously operating the first user interfaces X1 and Y1. Similarly, the second signal includes one of a second shifting signal and a second pairing trigger signal. In the embodiment, the second shifting signal is different from the second pairing trigger signal. For example, the second shifting signal is generated in response to a user individually operating to the second user interfaces X2 and Y2 and the second pairing trigger signal is generated in response to a user simultaneously operating the second user interfaces X2 and Y2.

Preferably, the controller 32 is configured to control the communicator 30 such that the communicator 30 operates intermittently in a state where the bicycle component BC is in the wireless signal listening mode. Also, preferably, as mentioned above, the signal amplifier 54 operates in the first power consumption state (i.e., a lower power consumption state than the second power consumption state of the pairing mode) in a state where the bicycle component BC is in the wireless signal listening mode. After entering the wireless signal listening mode, the controller 32 proceeds to step S4.

In step S2, when a device identification ID of a remote component (e.g., an operating device such as the first operating device 14 or the second operating device 24) is not already stored in the first non-volatile memory ROM1 of the first storage device 36, the controller 32 controls the communicator 30 such that communicator 30 communicates when communicator 30 receives a wireless signal regardless of the device identification ID included in the signal. That is, bicycle component BC enters into the wireless signal listening mode.

In step S3, the controller 32 controls the communicator 30 such that the communicator 30 communicates with the controller 32 only when the communicator 30 receives the signal from the paired remote component. That is, in the case where the ID of a remote component is stored in the first non-volatile memory ROM1 of the first storage device 36, the bicycle component BC enters into the shifting mode so that the remote component becomes the paired remote component. In the shifting mode, the communicator 30 stores the ID of the paired remote component in the second volatile memory RAM2 of the second storage device 38. Thus, in the shifting mode, the controller 42 of the communicator 30 determines whether a wireless signal should be processed, or not, by comparing the ID included in the wireless signal with the device identification ID of the paired remote component stored in the second volatile memory RAM2 of the second storage device 38.

In step S4, the controller 42 of the communicator 30 listens for a pairing trigger signal. In other words, if the first signal is received, the first signal includes a pairing trigger signal, and if the second signal is received, the second signal includes a pairing trigger signal. More specifically, the communicator 30 is configured to wirelessly receive a pairing trigger signal (the first signal or the second signal) generated in response to a user trigger input of a trigger input device. The trigger input device can be any device that can generate a wireless signal that is compatible with the communications protocol of the communicator 30. In other words, the trigger input device is not limited to the first input device 66 of the first remote component RC1 or the second input device 70 of the second remote component RC2. In the first embodiment, either the first input device 66 of the first remote component RC1 or the second input device 70 of the second remote component RC2 can be used as the trigger input device to generate the pairing trigger signal (the first signal or the second signal).

Preferably, in step S4, the controller 42 is configured to cause the bicycle component BC to enter a pairing mode in response to the pairing trigger signal (the first signal or the second signal) in a state where neither the first device identification nor the second device identification is stored in the first storage device. In other words, the controller 32 is configured to control the bicycle component BC in response to the first signal in a state where neither the first device identification ID1 nor the second device identification ID2 is stored in the first storage device 36. Also, the controller 32 is configured to control the bicycle component BC in response to the second signal in a state where neither the first device identification ID1 nor the second device identification ID2 is stored in the first storage device 36. In particular, when there are no device identifications stored in the first non-volatile memory ROM1 of the first storage device 36, the controller 32 is configured to control the bicycle component BC in response to receiving either the first signal or the second signal. In this way, the bicycle component BC can be controlled to perform a pairing process when no device identifications stored in the first non-volatile memory ROM1 of the first storage device 36.

For example, the first input device 66 includes the trigger input device. In other words, a user input of the first input device 66 can constitute a user trigger input of a trigger input device. More specifically, for example, a user can simultaneously depress (e.g., the user trigger input) the first user interfaces X1 and Y1 (e.g., the first interface) of the first input device 66 for a time period equal to two or more seconds to generate a wireless signal that corresponds to a pairing trigger signal. Thus, the user trigger input includes an input to the first interface. Alternatively, the second input device 70 can constitute a trigger input device where a user can simultaneously depress the second user interfaces X2 and Y2 (e.g., the user trigger input) of the second input device 70 for a time period equal to two or more seconds to generate a wireless signal that corresponds to a pairing trigger signal. Accordingly, in the illustrated embodiments, the first remote component RC1 includes at least one of the trigger input device and the first input device. Alternatively, the second remote component RC2 includes at least one of the trigger input device and the second input device. In other words, in the illustrated embodiments, either the first remote component RC1 or the second remote component RC2 can be configured to generate the pairing trigger signal. Also, in the illustrated embodiments, either the first remote component RC1 or the second remote component RC2 can be configured to be the input device that generates the pairing demand signal. Thus, the first remote component RC1 does not need to include both the trigger input device and the first input device, and the second remote component RC2 does not need to include both the trigger input device and the first input device.

In step S4, the controller 42 determines if the wireless signal is a pairing trigger signal or not. If a pairing trigger signal is not received, then the control process proceeds to step S5. On the other hand, if a pairing trigger signal is received, then the control process proceeds to step S6.

In step S5, the controller 42 of the communicator 30 determines if a first predetermined time (e.g., one to three seconds) has elapsed. If the first predetermined time has not elapsed, then the control process proceeds back to step S4 to continue to listen for a pairing trigger signal. If the first predetermined time has elapsed, then the control process ends. In other words, the controller 32 controls the communicator 30 to exit the wireless signal listening mode. In this way, the controller 32 is configured to cause the bicycle component BC to exit the wireless signal listening mode after the first predetermined time as elapsed from entering the wireless signal listening mode. Step S5 can be omitted if needed and/or desired. Specifically, step S5 can be omitted where the communicator 30 operates intermittently in the wireless listening mode and/or the signal amplifier operates in the first power consumption state in the wireless listening mode.

In step S6, the controller 32 is configured to cause the bicycle component BC to enter a pairing mode in response to the pairing trigger signal being received by the communicator 30. In other words, in step S6 the controller 32 is configured to cause the bicycle component BC to exit the wireless signal listening mode and to enter the pairing mode in response to the pairing trigger signal being received by the communicator 30. In this way, the pairing process begins. Next, the control process proceeds to step S7.

In step S7, the controller 32 is configured to activate the notification device 60 to produce a first notification in response to entrance of the bicycle component BC to the pairing mode. For example, the blue LED of the notification device 60 can start flashing in a 0.5 second cycle during the pairing mode. Next, the control process proceeds to step S8.

In step S8, the controller 32 controls the controller 42 of the communicator 30 to listen for a pairing demand signal. More specifically, the communicator 30 is configured to wirelessly receive a first pairing demand signal generated in response to a first user input of the first input device 66. Here, in the illustrated example, the first input device 66 of the first remote component RC1 is used to generate the first pairing demand signal. However, alternatively, the second input device 70 of the second remote component RC2 can be used as a first input device to generate the first pairing demand signal. In other words, the first pairing demand signal is generated by an input device of a remote component that is desired to be paired with the bicycle component BC (e.g., the rear derailleur 12).

More specifically, the first user input includes an input to a first interface of the first input device 66. Here, for example, a user can simultaneously depress (e.g., the first user input) the first user interfaces X1 and Y1 (e.g., the first interface) of the first input device 66 for a time period equal to one or more seconds to generate a wireless signal that corresponds to a first pairing demand signal, which includes the first device identification ID1 for the first communication device 64 of the first operating device 14. The first remote component RC1 (e.g., the first operating device 14) can be configured so that a pairing demand signal, which includes the first device identification ID1, is not transmitted until after a notification or some information is generated in the first remote component RC1 (e.g., the first operating device 14). In the illustrated embodiment, the notification device 60 is configured to produce a notification after at least one of informing information is generated in the first remote component RC1 and the first user input has finished. For example, the notification device 14C of the first operating device 14 can generate a notification (e.g., an LED being illuminated) to inform a user of information relating to a completion of a particular event, or information relating to a current status of the remote component or the bicycle component BC (e.g., the rear derailleur 12). In other words, the controller of the remote component RC1 (e.g., the first operating device 14) controls the notification device 14C to selectively illuminate the LEDs of the notification device 14C to produce a notification (e.g., a solid continuous light or a flashing light of a predetermined color) to indicate information relating to a current status of the remote component or the bicycle component BC (e.g., the rear derailleur 12). In the case, where the remote component is, for example, the second operating device 24, a notification device 24C (a display screen) of the second operating device 24 can be used to indicate information relating to a current status of the remote component or the bicycle component BC (e.g., the rear derailleur 12). The information that can be displayed includes a battery level of the remote component. Thus, the first pairing demand signal is not generated until after a user simultaneously depress the second user interfaces X2 and Y2 (e.g., the second user input) of the second input device 70 for a time period equal to one or more seconds and the notification device 24C displays the battery level of the second remote component RC2.

In step S8, if a pairing demand signal is not received, then the control process proceeds to step S9. On the other hand, if a pairing demand signal is received, then the controller 32 is configured to establish wireless communication between the bicycle component BC and the first remote component RC1 that sent the first pairing demand signal in a state where the bicycle component BC is in the pairing mode, and the control process proceeds to step S10.

In step S9, the controller 32 determines if a second predetermined time (e.g., two to three seconds) has elapsed. If the second predetermined time has not elapsed, then the control process proceeds back to step S8 to continue to listen for a pairing demand signal. If the second predetermined time has elapsed, then the control process ends. Step S9 can be omitted if needed and/or desired. Specifically, step S9 can be omitted where the communicator 30 operates intermittently in the pairing mode and/or the signal amplifier operates in the first power consumption state in the pairing mode.

In step S10, the controller 32 controls the controller 42 of the communicator 30 to store the first device identification ID1 in the second storage device 38. In particular, the first device identification ID1 is first temporarily stored in the second volatile memory RAM2. Here, as mentioned above, the first device identification ID1 identifies the first communication device 64 of the first remote component RC1. Thus, the wireless signals generated by the first communication device 64 includes the first device identification ID1, which is received by the communicator 30 so the controller 42 can determine the source of the wireless signal as being from the first communication device 64 of the first remote component RC1. At this point, the notification device 60 is not illuminated. However, the communicator 30 can transmit an acknowledgement signal to the first communication device 64 upon receiving and storing the first device identification ID1. The first remote component RC1 can produce a notification to the user. For example, the first operating device 14 (e.g., the first remote component RC1) can illuminate an LED of the notification device 14C to notify a user that the first device identification ID1 has been received and stored in the second volatile memory RAM2 of the second storage device 38 of the communicator 30. Next, the control process proceeds to step S11.

In step S11, the controller 32 is configured to activate the notification device 60 to produce a second notification in a state where the bicycle component BC has been successfully paired. The phrase “successfully paired” as used herein refers a situation in which the first device identification ID1 has been stored in the second volatile memory RAM2. Preferably, the second notification is different from the first notification. For example, where the first notification is a flashing blue light, the second notification can be a solid color light of any color, or a flashing light other than a blue light. Next, the control process proceeds to step S12.

In step S12, the controller 32 determines whether a pairing confirmation signal has been received. The pairing confirmation signal also constitutes an exit signal. The pairing confirmation signal can be generated by a user input to the interface 74 (e.g., the button) provided on the bicycle component BC (e.g., the rear derailleur 12) that is being paired. For example, the interface 74 can be depressed for a predetermined amount of time such as 0.5 second or more. Alternatively, the pairing confirmation signal can be generated by different interface than the interface 74. For example, the pairing confirmation signal can be sent from a communication device one of the remote components that was paired such as by operating one of the first user interfaces provided on the first communication device 64 (the first remote component RC1). As mentioned above, the interface 74 corresponds to the third input device. While the illustrated embodiments have the interface 74 provided on the rear derailleur 12, the third user input (e.g., the exit interface) can be provided on at least one of the bicycle component BC, the first remote component RC1 and the second remote component RC2. In step S12, the pairing confirmation signal corresponds to a third user input of a third input device (e.g., the interface 74). Thus, in step S12, the controller 32 is configured to cause the bicycle component BC to exit the pairing mode in response to a third user input of a third input device.

If a pairing confirmation signal has not received, then the control process resets the timer for the second predetermined time and proceeds back to step S8 to continue to listen for another pairing demand signal. In this way, one or more additional remote components can be paired to the bicycle component BC (e.g., the rear derailleur 12). If a pairing confirmation signal has received, then the control process proceeds to step S13. However, if the pairing is not confirmed, all the pairings are cancelled. In other words, the device identifications stored in the second volatile memory RAM2 will be removed.

A timer can be added to step S12 such that if the pairing confirmation signal is not received in a predetermined time period from entering the pairing mode, the pairing is stopped and the device identifications stored in the second volatile memory RAM2 are be removed. In any case, after removing device identifications from the second volatile memory RAM2, the controller 32 of the bicycle component BC exits from pairing mode. After exiting from pairing mode, the control process can start back at step S2 as needed and/or desired. Alternatively, after exiting from paring mode, the control process will not be executed unless a prescribed trigger event occurs.

In step S8, after receiving and storing the first device identification ID1 in a previous cycle, the communicator 30 is configured to wirelessly receive a second pairing demand signal generated in response to a second user input of a second input device. Here, for example, the second input device 70 of the second remote component RC2 can be a second input device configured to generate the second pairing demand signal. Thus, the controller 32 is configured to establish wireless communication between the bicycle component BC and the second remote component RC2 that sent the second pairing demand signal in a state where the bicycle component BC is in the pairing mode.

In step S8, after receiving and storing the first device identification ID1 in a previous cycle, if a second pairing demand signal is not received, then the control process proceeds to step S9. Since the timer for the second predetermined time has been reset, the user has adequate time to operate the second input device 70 of the second remote component RC2 to generate the second pairing demand signal.

In step S8, after receiving and storing the first device identification ID1 in a previous cycle, if the second predetermined time has not elapsed, then the control process proceeds back to step S8 to continue to listen for a pairing demand signal. If the second predetermined time has elapsed, then the control process step S11 where the controller 32 determines whether a pairing demand signal has been received. In this way, several remote components can be paired to the bicycle component BC (e.g., the rear derailleur 12). However, if the pairing confirmation signal is not received within a predetermined period of time, then all of the device identifications stored in the second volatile memory RAM2 of the second storage device 38 will be cleared from the second volatile memory RAM2 of the second storage device 38.

In step S14, after the pairing confirmation signal has been received, the controller 32 is configured to store the device identifications in the first storage device 36. In other words, the first storage device 36 is configured to store the first device identification ID1 included in the first pairing demand signal that is received by the communicator 30. In particular, the device identifications are stored in the first non-volatile memory ROM1 of the first storage device 36. In this way, the device identifications remain stored in the first non-volatile memory ROM1 of the first storage device 36 even when the electrical power is disconnected from the bicycle component BC (e.g., the rear derailleur 12). However, the user can clear the device identifications stored in the first non-volatile memory ROM1 of the first storage device 36 by using the external device ED. Then, the control process proceeds to step S15.

In step S15, the controller 32 is configured to activate the notification device 60 to produce a third notification in response the completion of the pairing mode for establishing wireless communication between the bicycle component BC (e.g., the rear derailleur 12) and at least one remote component. The phrase “establishing wireless communication” used herein refers a situation in which the first non-volatile memory ROM1 of the first storage device 36 stores at least one device identification (e.g., the first device identification ID1). That is, the phrase “establishing wireless communication” as used herein refers a situation in which the bicycle component BC has exited the pairing mode and has entered the shifting mode so that the bicycle component BC (e.g., the rear derailleur 12) can be operated by the paired remote component having the device identification stored in the first non-volatile memory ROM1 of the first storage device 36.

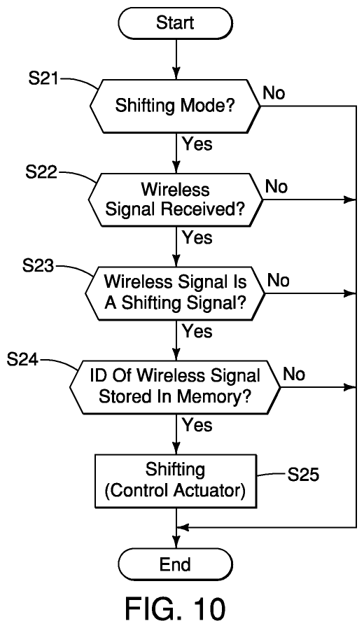

Referring now to FIG. 10, a control process will now be discussed where a bicycle component BC (e.g., the rear derailleur 12) is operated. In other words, in the case of the rear derailleur 12, the control process of FIG. 10 is a shifting control process where the rear derailleur 12 has been paired to another bicycle component BC (e.g., the first operating device 14 and/or the second operating device 24). This control process can be used in each of the bicycle control systems 10, 110 and 210 to wirelessly control the bicycle component BC (e.g., the rear derailleur 12). This control process will be explained using the rear derailleur 12 as the bicycle component BC that has been paired with one or two remote components where the first operating device 14 corresponds to the first remote component RC1 and the second operating device 24 corresponds to the second remote component RC2. However, the control process can be used with other components.

In this control process of FIG. 10, the control process can be a separate control process or a subroutine of step S3 of the control proceeds of FIG. 9. In the case of the control process of FIG. 10 being a subroutine of step S3 of the control proceeds of FIG. 9, the pairing demand signal is the same as the pairing trigger signal. In other words, when the communicator 30 receives an appropriate signal such as a wireless signal produced by operating either the first operating device 14 or the second operating device 24, the controller 42 of the communicator 30 starts the control process of FIG. 10. Basically, the communicator 30 is configured to wirelessly receive a first signal including a first device identification ID1 generated from a first communication device and a second signal including a second device identification ID2 generated from a second communication device. In other words, in the illustrated examples, the communicator 30 of the rear derailleur 12 (i.e., the bicycle component BC being paired) is configured to wirelessly receive a first signal including the first device identification ID1 generated from the first communication device 64 of the first operating device 14 (e.g., the first remote component RC1) and a second signal including the second device identification ID2 generated from the second communication device 68 of the second operating device 24 (e.g., the second remote component RC2).

In step S21 of the control process of FIG. 10, the controller 32 first determines if the rear derailleur 12 (i.e., the bicycle component BC being paired) is in the shifting mode. If the rear derailleur 12 has not entered the shifting mode, then the control process of FIG. 10 ends. If the controller 32 determines the rear derailleur 12 has entered the shifting mode, then the control process proceeds to Step S22.

In step S23, the controller 32 determines if the wireless signal (e.g., the first signal or the second signal) is a shifting signal. If the wireless signal (e.g., the first signal or the second signal) is determined not to be a shifting signal (e.g., the first shifting signal or the second shifting signal), then the control process of ends. If the wireless signal (e.g., the first signal or the second signal) is determined to be a shifting signal, then the control process proceeds to step S24.

In step S24, the controller 32 determines if the device identification ID of the wireless signal is stored in the memory (e.g., the first non-volatile memory ROM1 of the first storage device 36) of the controller 32. For example, if the first device identification ID1 is stored in the memory of the controller 32, and the first signal having the first device identification ID1 is received, then the control process proceeds to step S25. Likewise, if the second device identification ID2 is stored in the memory of the controller 32, and the second signal having the second device identification ID2 is received, then the control process proceeds to step S25. On the other hand, if the first device identification ID1 is not stored in the memory of the controller 32, and the first signal having the first device identification ID1 is received, then the control process ends. Similarly, if the first device identification ID1 is stored in the memory of the controller 32, and the second signal having the second device identification ID2 is received, then the control process ends.

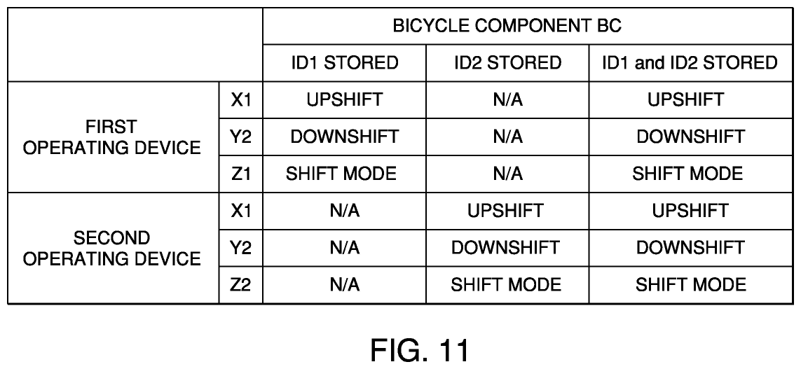

In step S25, the controller 32 operates the rear derailleur 12 (i.e., the bicycle component BC) according to the shifting program based on the device identifications stored in the first storage device 36 (See, for example storage table of FIG. 11). In other words, when the first device identification ID1 is stored in the memory of the controller 32, and the first signal (the first shifting signal) having the first device identification ID1 is received, then the controller 32 controls the rear derailleur 12 according to the first signal (the first shifting signal) using the shifting program stored in the first storage device 36. In this way, the first operating device 14 can be used to control the rear derailleur 12 by generating the first shifting signal. Similarly, when the second device identification ID2 is stored in the memory of the controller 32, and the second signal (the second shifting signal) having the second device identification ID2 is received, then the controller 32 controls the rear derailleur 12 according to the second signal (the second shifting signal) using the shifting program stored in the first storage device 36. In this way, the second operating device 24 be used to control the rear derailleur 12 by generating the second shifting signal.

Thus, in this control process, either the first signal or the second signal includes a shifting signal, or either the first signal or the second signal includes a pairing trigger signal. In other words, in one example, the first signal includes a pairing trigger signal. In another example, the second signal includes a pairing trigger signal.

The controller 32 may operate the actuator 56 differently depending on the device identifications stored in the first non-volatile memory ROM1 of the first storage device 36. In any case, the controller 32 will control the bicycle component BC (e.g., the rear derailleur 12) based on which device identifications are stored, if any, in the first non-volatile memory ROM1 of the first storage device 36. For example, as seen in FIG. 11, the controller 32 is configured to control the bicycle component BC in response to the first signal in a state where the first device identification ID1 is stored in the first storage device 36. In the illustrated example, the first signal including a first shifting signal. Thus, the controller 32 is configured to control the actuator 56 in response to the first shifting signal in a state where the first device identification ID1 is stored in the first storage device 36. However, the controller 32 is further configured to control the bicycle component BC such that the bicycle component BC is unresponsive to the first shifting signal in a state where the first device identification ID1 is not stored in the first storage device 36 and the second device identification ID2 is stored in the first storage device 36.

Likewise, as seen in FIG. 11, the controller 32 is further configured to control the bicycle component BC in response to the second signal in a state where the second device identification ID2 is stored in the first storage device 36. In the illustrated example, the second signal including a second shifting signal. Thus, the controller 32 is configured to control the actuator 56 in response to the second shifting signal in a state where the second device identification ID2 is stored in the first storage device 36. Also, the controller 32 is further configured to control the bicycle component BC such that the bicycle component BC is unresponsive to the second shifting signal in a state where the second device identification ID2 is not stored in the first storage device 36 and the first device identification ID1 is stored in the first storage device 36.

Moreover, as seen in FIG. 11, the controller 32 is further configured to selectively control the bicycle component BC in response to at least one of the first signal and the second signal in a state where the first device identification ID1 and the second device identification ID2 are stored in the first storage device 36. In other words, either the first operating device (i.e., the first remote component RC1) or the second operating device 24 (i.e., the second remote component RC2) can be used to control the rear derailleur 12 (i.e., the bicycle component BC) when the first device identification ID1 and the second device identification ID2 are both stored in the first storage device 36. Accordingly, the controller 32 is configured to control the bicycle component BC in accordance with a control signal including one of the device identifications stored in the first storage device 36.

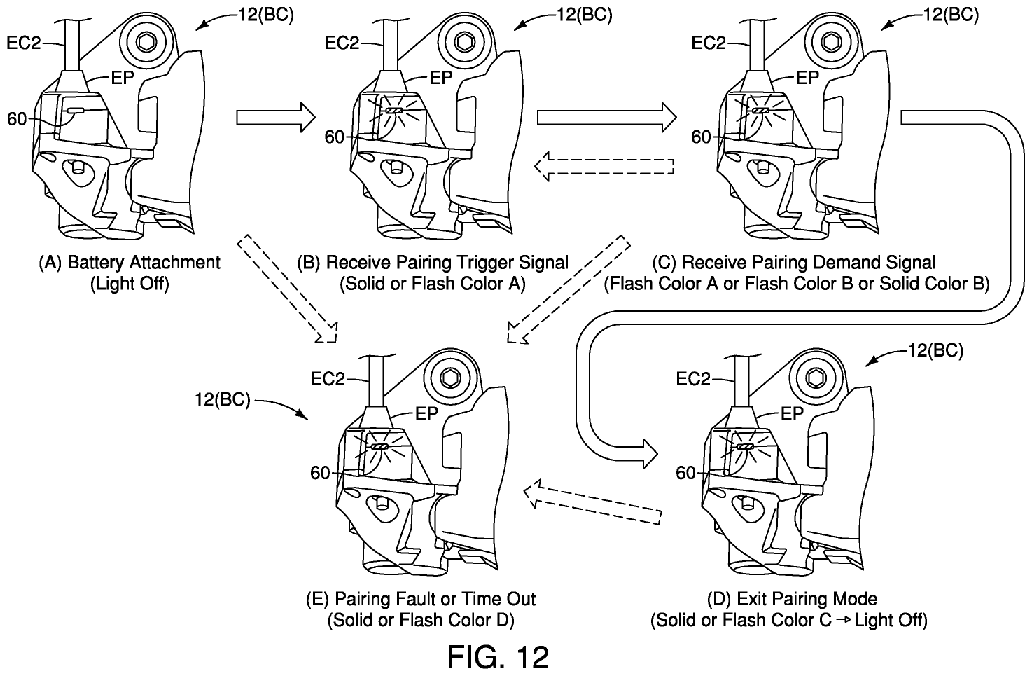

Referring now to FIG. 12, one example of a notification sequence of the notification device 60 is illustrated for the rear derailleur 12 (i.e., the bicycle component BC). Here, the notification device 60 produces a notification using one or more LED's to produce various light notifications. However, the notification device 60 is not limited to using light as a notification. For example, the rear derailleur 12 can produce notifications by actuating the motor based on the signals received. More specifically, for example, when receiving the pairing trigger signal, the motor moves intermittently in a first moving cycle and a first moving amount. On the other hand, when the pairing demand signal is received, the motor moves intermittently in a second moving cycle and a second moving amount. At least one of the second moving cycle and the second moving amount differs from the first moving cycle and the first moving amount, respectively.

As indicated by part (A) of FIG. 12, before receiving electrical power, the notification device 60 of the rear derailleur 12 in inoperative. When electrical power is supplied to the rear derailleur 12, and thus, to notification device 60 of the rear derailleur 12, the notification device 60 is not illuminated as indicated by part (A) of FIG. 12. As mentioned above, when electrical power is supplied to the rear derailleur 12, the rear derailleur 12 enters a wireless signal listening mode. Thus, during the wireless signal listening mode, the notification device 60 is not illuminated.

As indicated by part (B) of FIG. 12, once the communicator 30 receives a pairing trigger signal, the notification device 60 produces a first notification such as a solid or flashing light with a color A (e.g., blue). This first notification indicates the rear derailleur 12 has entered the pairing mode.

Next, as indicated by part (C) of FIG. 12, once the communicator 30 receives a pairing demand signal, the notification device 60 produces a different second notification such as a flashing light with the color A (e.g., blue), switching to a flashing light with a color B (e.g., green), or switching to a solid light with the color B (e.g., green). This second notification indicates the pairing process is in progress. After second notification, the notification device 60 moves to the first notification when another pairing trigger signal is received to pair an additional remote component.

As indicated by part (D) of FIG. 12, once the confirmation signal is received and the device identifications are stored in the first storage device 36, the notification device 60 produces a different third notification such as a solid light or a flashing light with a color C (e.g., green or another color). This third notification remains on for a predetermined time and then the light turns off.

As indicated by part (E) of FIG. 12, if at any time a pairing fault occurs or a timeout occurs, the notification device 60 produces a different fourth notification such as a solid light or a flashing light with a color D (e.g., red). The fourth notification is a pairing fault notification or pairing error notification that can be generated at any time a pairing fault occurs or a timeout occurs during the pairing process.

While the rear derailleur 12 was used in the illustrated embodiments as the bicycle component BC to describe the present invention, it will be apparent from this disclosure that bicycle component BC of the present invention can include a front derailleur or an internal transmission (e.g., an internal derailleur).

Moreover, in accordance with an alternate embodiment, steps S2 to S7 can be omitted. In accordance with this alternate embodiment, once a battery or an electrical cable is attached to the bicycle component BC (e.g., the rear derailleur 12), the bicycle component BC enters into the pairing mode for a predetermined amount of time in accordance with steps S8 to S15.

Moreover, in accordance with another alternate embodiment, the bicycle component BC (e.g., the rear derailleur 12) can be shipped so that the bicycle component BC (e.g., the rear derailleur 12) is immediately ready to pair with an input device. For example, the bicycle component BC (e.g., the rear derailleur 212) is provided with the electric power supply 228 that is electrically connected to the printed circuit board 34. In this way, the communicator 30 and the controller 32 already have electrical power supplied from the electric power supply 228 and the bicycle component BC (e.g., the rear derailleur 12) is in the pairing mode when shipped. Thus, in this alternate embodiment, steps S2 to S7 can be omitted. Also, in this alternate embodiment, the predetermined amount of time for carrying out the pairing process can also be omitted.

Alternatively, the control process can be configured such that the pairing trigger signal can be the same signal as the shifting signal. In other words, the following control process is carried out in response to the same signal (i.e., either a pairing trigger signal or a shifting signal). The controller 32 is configured to control the bicycle component BC to cause the bicycle component BC to enter a pairing mode in response to the first signal (i.e., either a pairing trigger signal or a shifting signal signal) in a state where neither the first device identification ID1 nor the second device identification ID2 is stored in the first storage device 36. The controller 32 is configured to control the bicycle component to cause the bicycle component to enter a pairing mode in response to the second signal (i.e., either a pairing trigger signal or a shifting signal) in a state where neither the first device identification ID1 nor the second device identification ID2 is stored in the first storage device 36. The controller 32 is further configured to control the bicycle component BC (e.g., control the actuator 56) in response to the first signal (i.e., either a pairing trigger signal or a shifting signal) in a state where the first device identification ID1 is stored in the first storage device ID2. The controller 32 is further configured to control the bicycle component BC (e.g., control the actuator 56) in response to the second signal (i.e., either a pairing trigger signal or a shifting signal) in a state where the second device identification ID2 is stored in the first storage device ID2.

The control process can be modified such that the control process can be stopped by at anytime by the user. For example, the interface 74 can be operated by a user at anytime to exit the control process. In other words, the user can exit the pairing mode using the interface 74. When the user exits the pairing mode using the interface 74 prior to receiving a pairing confirmation signal, all of the device identifications stored in the second volatile memory RAM2 of the second storage device 38 will be cleared from the second volatile memory RAM2 of the second storage device 38.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a bicycle in an upright, riding position and equipped with the bicycle component. Accordingly, these directional terms, as utilized to describe the bicycle component should be interpreted relative to a bicycle in an upright riding position on a horizontal surface and that is equipped with the bicycle component. The terms “left” and “right” are used to indicate the “right” when referencing from the right side as viewed from the rear of the bicycle, and the “left” when referencing from the left side as viewed from the rear of the bicycle.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A bicycle component comprises:
a communicator configured to wirelessly receive a pairing trigger signal generated in response to a user trigger input of a trigger input device, and to wirelessly receive a first pairing demand signal generated in response to a first user input of a first input device; and
a controller configured to cause the bicycle component to enter a pairing mode in response to the pairing trigger signal being received by the communicator,
the controller being configured to establish wireless communication between the bicycle component and a first remote component that sent the first pairing demand signal in a state where the bicycle component is in the pairing mode.

2. The bicycle component according to claim 1, wherein
the first remote component includes at least one of the trigger input device and the first input device.

3. The bicycle component according to claim 1, wherein
the first input device includes the trigger input device.

4. The bicycle component according to claim 3, wherein
the first user input includes an input to a first interface of the first input device, and
the user trigger input includes an input to the first interface.

5. The bicycle component according to claim 1, wherein
the bicycle component is configured to enter a wireless signal listening mode in response to a trigger, and
the controller is configured to cause the bicycle component to exit the wireless signal listening mode and to enter the pairing mode in response to the pairing trigger signal being received by the communicator.

6. The bicycle component according to claim 5, wherein
the trigger includes at least one of providing electrical power to the bicycle component, connecting a power source to the bicycle component, connecting an electrical cable connected to an additional bicycle component, and operating an additional control device configured to control the additional bicycle component.

7. The bicycle component according to claim 5, wherein
the controller is configured to prohibit the bicycle component from entering the wireless signal listening mode in a state where wireless communication between the bicycle component and the first remote component is established.

8. The bicycle component according to claim 5, wherein
the controller is configured to cause the bicycle component to exit the wireless signal listening mode after a first predetermined time as elapsed from entering the wireless signal listening mode.

9. The bicycle component according to claim 5, wherein
the controller is configured to control the communicator such that the communicator operates intermittently in a state where the bicycle component is in the wireless signal listening mode.

10. The bicycle component according to claim 5, further comprising
a signal amplifier coupled to the communicator, and
the controller being configured to control the signal amplifier such that the signal amplifier operates in a first power consumption state in a state where the bicycle component is in the wireless signal listening mode,
the controller being configured to control the signal amplifier such that the signal amplifier operates in a second power consumption state in a state where the bicycle component is in the pairing mode,
the first power consumption state having a lower power consumption than the second power consumption state.

11. The bicycle component according to claim 5, further comprising
a notification device being configured to be controlled by the controller.

12. The bicycle component according to claim 11, wherein
the notification device includes a light emitting device.

13. The bicycle component according to claim 11, wherein
the notification device is configured to produce a notification after at least one of informing information is generated by the first remote component and the first user input has finished.

14. The bicycle component according to claim 11, wherein
the controller is configured to activate the notification device to produce a first notification in response to entrance of the bicycle component to the pairing mode.

15. The bicycle component according to claim 11, wherein
the controller is configured to activate the notification device to produce a second notification in a state where the bicycle component has been successfully paired.

16. The bicycle component according to claim 1, wherein
the controller is configured to cause the bicycle component to exit the pairing mode in response to a third user input of a third input device, and
the third input device is provided on at least one of the bicycle component and the first remote component.

17. The bicycle component according to claim 1, wherein
the communicator is configured to wirelessly receive a second pairing demand signal generated in response to a second user input of a second input device, and
the controller is configured to establish wireless communication between the bicycle component and a second remote component that sent the second pairing demand signal in a state where the bicycle component is in the pairing mode.

18. The bicycle component according to claim 1, further comprising
a first storage device configured to store a first device identification included in the first pairing demand signal that is received by the communicator.

19. The bicycle component according to claim 17, further comprising
a first storage device configured to store at least one of device identifications including a first device identification and a second device identification, the first device identification being included in the first pairing demand signal that is received by the communicator, the second device identification being included in the second pairing demand signal that is received by the communicator,
the controller being configured to control the bicycle component in accordance with a control signal including one of the device identifications stored in the first storage device.

20. The bicycle component according to claim 18, wherein
the controller is configured to clear the device identification stored in the first storage device in response to a reset operation of a reset interface.

21. The bicycle component according to claim 20, further comprising
the reset interface operatively coupled to the controller, the controller being configured to disable the reset operation upon a command from an external device.

22. The bicycle component according to claim 1, wherein
the controller is configured to cause the bicycle component to exit the pairing mode after a second predetermined time as elapsed.

23. A bicycle control system comprising:
the bicycle component according to claim 1; and
the first remote component.

24. A bicycle component comprises:
a communicator configured to wirelessly receive a first signal including a first device identification generated from a first communication device and a second signal including a second device identification generated from a second communication device;
a first storage device configured to store at least one of the first device identification and the second device identification; and
a controller configured to control the bicycle component in response to the first signal in a state where neither the first device identification nor the second device identification is stored in the first storage device,
the controller configured to control the bicycle component in response to the second signal in a state where neither the first device identification nor the second device identification is stored in the first storage device,
the controller being further configured to control the bicycle component in response to the first signal in a state where the first device identification is stored in the first storage device.

25. The bicycle component according to claim 24, further comprising
an actuator, and
the first signal including a first shifting signal,
the controller configured to control the actuator in response to the first shifting signal in a state where the first device identification is stored in the first storage device.

26. The bicycle component according to claim 25, wherein
the controller is further configured to control the bicycle component such that the bicycle component is unresponsive to the first shifting signal in a state where the first device identification is not stored in the first storage device and the second device identification is stored in the first storage device.

27. The bicycle component according to claim 24, wherein
the first signal includes a pairing trigger signal, and
the controller is configured to cause the bicycle component to enter a pairing mode in response to the pairing trigger signal in a state where neither the first device identification nor the second device identification is stored in the first storage device.

28. The bicycle component according to claim 24, wherein
the controller is further configured to control the bicycle component in response to the second signal in a state where the second device identification is stored in the first storage device.

29. The bicycle component according to claim 28, wherein
the controller is further configured to selectively control the bicycle component in response to at least one of the first signal and the second signal in a state where the first device identification and the second device identification are stored in the first storage device.
